(19) United States
(12) Patent Application Publication
(10) Pub. No.: US 2009/0138465 A1
(43) Pub. Date: May 28, 2009

(54) TECHNICAL DOCUMENT ATTRIBUTE ASSOCIATION ANALYSIS SUPPORTING APPARATUS

(76) Inventors: Hiroaki Masuyama, Osaka (JP); Makoto Asada, Tokyo (JP); Kazumi Hasuko, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/097,446

(22) PCT Filed: Dec. 13, 2006
(86) PCT No.: PCT/JP2006/324876

§ 371 Date: Jun. 13, 2008

(30) Foreign Application Priority Data
Dec. 13, 2005 (JP) 2005-358529
Nov. 2, 2006 (JP) PCT/JP2006/321958

(51) Int. Cl. G06F 7/06; G06F 17/30

(52) U.S. Cl. 707/5; 707/102; 707/E17.014; 707/E17.046

(57) ABSTRACT

Data on a group of technical documents having an attribute X and an attribute Y is acquired and a score corresponding to the data on the technical documents belonging to the combination of the attribute X and attribute Y is calculated. The attribute X is placed on the horizontal axis and the attribute Y is placed on the vertical axis. The scores are placed in a matrix manner. According to the scores belonging to each column of the arrangement in the matrix, a group of vectors Xⱼ are generated. According to the scores belonging to each row, a group of vectors Yₖ are generated. For each of the groups of vectors Xⱼ, Yₖ, vectors having higher association with each other are placed nearer to each other. The associations between the vectors of the first group corresponding to the first attribute X of the technical document and the associations between the vectors of the second group corresponding to the second attribute Y are analyzed in detail, and examination in consideration of both first and second attributes X, Y can be performed.

### TECHNICAL FIELD

The present invention relates to an analysis supporting apparatus, a supporting method and a supporting program, for analyzing an association of a document attribute in a group of technical documents.

### BACKGROUND ART

It is not easy for a company itself to grasp the technical development achievement expanded in a research and development organization of the company or the current situation of the technical asset portfolio and to establish an objective guideline for a direction of future development. As a method to obtain the objective guideline for the company's direction of development, it appears to be effective to collect and analyze data obtained from groups of technical documents of a user's company and of other companies. However, there will be a significant difficulty in extracting useful information from enormous numbers of technical documents.

Conventionally, as an attempt to uncover information buried in an enormous amount of data, there is analyzing a cross table which is prepared such that two types of terms, i.e., Xⱼ (j=1, 2, . . . , p) and Yₖ (k=1, 2, . . . , q), for example, are placed on a horizontal axis and a vertical axis and aggregate results by each combination of these terms are presented in a table.

In Dual Scaling described in the following non-patent document 1, for example, scales Xⱼ (j=1, 2, . . . , p) and scales Yₖ (k=1, 2, . . . , q) are assigned to the terms Xⱼ (row of table) on the horizontal axis of the cross table and the terms Yₖ (column of table) on the vertical axis, respectively, to find tendencies hidden in the cross table. In the non-patent document 1, in order to calculate specific numerical values of the scales Xⱼ and the scales Yₖ, components of a vector X and a vector Y are evaluated such that a square value of a coefficient of correlation between a p-dimensional vector X=(X₁, X₂, . . . , Xₚ) and q-dimensional vector Y=(Y₁, Y₂, . . . , Y_{q}) is as near 1 as possible.

[Non-patent document 1]

“Practical Workshop Thorough Utilization of Excel Multivariate Analysis” by Taichirou UEDA, et al., SHUWA SYSTEM Co., Ltd., published on Sep. 5, 2003, on pages 323 to 337.

### DISCLOSURE OF THE INVENTION

### Problem to be Solved by the Invention

However, the above-described Dual Scaling and other conventional techniques do not sufficiently analyze the mutual relationship of terms Xⱼ (j=1, 2, . . . , p) on the vertical axis of the cross table or that of terms Yₖ (k=1, 2, . . . , q) on the horizontal axis thereof. Therefore, it is not possible to sufficiently conduct an examination based on a consideration of both Xⱼ and Yₖ. In the Dual Scaling, the scales are applied to Xⱼ and Yₖ, respectively, however, information obtained therefrom is limited. Even when this technique is used, an association of a document attribute in a group of technical documents cannot be sufficiently analyzed. Therefore, the information cannot be used as a determination reference to establish an objective guideline for a company's direction of technical development.

An object of the present invention is to provide a technical document attribute association analysis supporting apparatus, a supporting method thereof, and a supporting program thereof, in which a mutual association of a first group of vectors which corresponds to a first attribute X of technical documents and a mutual association of a second group of vectors which corresponds to a second attribute Y are analyzed in detail and an examination in consideration of both the first attribute X and the second attribute Y are conducted, whereby a state of concentration or dispersion of a data distribution of each document attribute in a group of technical documents can be recognized, and the determination reference for a company's direction of technical development can be indicated.

### Means for Solving the Problem

(1) In order to solve the above-described problem, a technical document attribute association analysis supporting apparatus of the present invention comprises:

data acquiring means for acquiring data of a group of technical documents including a plurality of technical documents each of which has at least two attributes;

score calculating means for calculating scores corresponding to data of the technical documents belonging to each combination of a first attribute X and a second attribute Y, out of the at least two attributes;

first group-of-vectors generating means for generating vectors based on the scores belonging to each column in a matrix manner arrangement where the scores are arranged in the matrix manner in which the first attribute X is placed on a horizontal axis and the second attribute Y is placed on a vertical axis;

first vector association calculating means for calculating mutual associations with respect to the group of vectors generated by the first group-of-vectors generating means;

first vector arranging means for arranging vectors of high association closer to each other, with respect to the group of vectors generated by the first group-of-vectors generating means;

second group-of-vectors generating means for generating vectors based on the scores belonging to each row in the matrix manner arrangement;

second vector association calculating means for calculating mutual associations with respect to the group of vectors generated by the second group-of-vectors generating means; and

second vector arranging means for arranging vectors of high association closer to each other, with respect to the group of vectors generated by the second group-of-vectors generating means.

According to this, the mutual association of vectors each of which corresponds to the first attribute X (each column of scores arranged in a matrix manner) is calculated to arrange vectors having a similar distribution of the second attribute Y closer to each other, and the mutual association of vectors each of which corresponds to the second attribute Y (each row of scores arranged in a matrix manner) is calculated to arrange vectors having a similar distribution of the first attribute X closer to each other. Therefore, the mutual association of the vectors corresponding to the first attribute X and that of the vectors corresponding to the second attribute Y are analyzed in detail, and in addition, the association is examined in consideration of both the first attribute X and the second attribute Y. Thus, it becomes possible to recognize a state of concentration or dispersion of the data distribution of the document attribute in the group of technical documents.

(2) In the technical document attribute association analysis supporting apparatus, it is preferable that,

one of the first attribute X and the second attribute Y is a person attribute of each technical document and the other is a technical field attribute of each technical document.

For example, the person attribute includes an applicant, an inventor, etc., in the case of a patent document, and includes an author, an editor, etc., in the case of a technical paper or a book. The technical field attribute includes a technical classification such as IPC (International Patent Classification) as well as a technical element, a keyword, etc.

According to this, the mutual association of vectors which correspond to the person attribute and that of vectors which correspond to the technical field attribute are analyzed, and based on this, the association can be examined in consideration of both the person attribute and the technical field attribute. For example, association in a technical development area between a user's company and another company is shown, and thus, companies which have a similar development orientation can be searched. The companies which have a similar development orientation used herein, is not limited to those which actually compete in the marketplace. In the case where a company which is compared with the user's company has a development orientation which resembles that of the user's company and has already entered an industry in which the user's company has not yet entered, it is anticipated that the technical barrier which the user's company needs to overcome for newly entering the industry is low. It is also possible to discover a strength/weakness of a development sector of the user's company, as compared to a company which competes with the user's company in the marketplace and has a different development orientation, or to search for a technical partner who can reciprocally compensate the weakness of the respective development sectors, thereby helping the user's company to form a policy for technical development in order to compete against the other companies in the industry in which the user's company intends to enter. It is further possible to analyze the association between the technical fields because, for example, the association of developers between a certain technical field and another technical field is shown. For example, when there is a high tendency that the same company handles technical fields to be compared: (a) it is possible to find out a possibility that the handling of the both fields has led to the current business so as to determine a potential for entering such a business or to determine a necessity of further technical development for entering such a business; or (b) it is possible to find out the possibility of mutual conversion of these technical fields in spite of lacking technical relationship at one view.

(3) In the technical document attribute association analysis supporting apparatus, it is preferable that

the score calculating means calculates the scores based on the number of technical documents having the same combination of (Xⱼ, Yₖ) of values Xⱼ (j=1, 2, . . . , p) of the first attribute X and values Yₖ (k=1, 2, . . . , q) of the second attribute Y.

When the scores are calculated based on the number of technical documents having the same combination, it becomes possible to express simply and objectively a state of concentration or dispersion of an attribute distribution.

(4) It is preferable that

the score calculating means calculates the scores by applying weightings to the technical documents having the same combination (Xⱼ, Yₖ) of values Xⱼ (j=1, 2, . . . , p) of the first attribute X and values Yₖ (k=1, 2, . . . , q) of the second attribute Y and totaling them.

When the scores are calculated by totaling the weightings of the technical documents having the same combination, appropriate analysis can be performed using scores to which an importance or a quality element of the technical document is added.

With respect to the weighting, when a larger weighting is assigned to a publication of registered patent, rather than to a publication of patent application, for example, the importance or the quality of the technical document is emphasized.

(5) In the technical document attribute association analysis supporting apparatus, it is preferable that

the first group-of-vectors generating means or the second group-of-vectors generating means generates a vector which includes, as a component, a logarithm of each of the scores belonging to each column or each row in the matrix manner arrangement.

According to this, particularly, in the case where each score is non-negative and the scores are concentrated adjacent to 0, a distribution of vector components is rendered close to a normal distribution. As a result, the reliability of the association calculation result can be improved.

(6) In the technical document attribute association analysis supporting apparatus, it is preferable that

the first vector arranging means comprises:
first cluster generating means for selecting two vectors out of the group of vectors generated by the first group-of-vectors generating means based on a predetermined criterion and bringing the two vectors next to each other to generate a cluster, and
first cluster enlarging means for successively enlarging the cluster by: selecting, as an additional vector, a vector having highest association with either one of end vectors positioned at both ends, out of the group of vectors configuring the cluster generated by the first cluster generating means, from the vectors other than the cluster out of the group of vectors generated by the first group-of-vectors generating means; and bringing the additional vector next to an end vector which is determined to have the highest association with the additional vector to thereby add the additional vector to the cluster; and/or

the second vector arranging means comprises:
second cluster generating means for selecting two vectors out of the group of vectors generated by the second group-of-vectors generating means based on a predetermined criterion and bringing the two vectors next to each other to generate a cluster, and
second cluster enlarging means for successively enlarging the cluster by: selecting, as an additional vector, a vector having highest association with either one of end vectors positioned at both ends, out of the group of vectors configuring the cluster generated by the second cluster generating means, from the vectors other than the cluster out of the group of vectors generated by the second group-of-vectors generating means; and bringing the additional vector next to an end vector which is determined to have the highest association with the additional vector to thereby add the additional vector to the cluster.

According to this, vectors having higher association are brought next to each other in succession to enlarge the cluster, and thus, the vectors having a high association are reliably arranged close to each other and a state of concentration or dispersion of the data distribution of the document attributes can be explicitly specified.

(7) In the technical document attribute association analysis supporting apparatus, it is preferable that

the first cluster generating means or the second cluster generating means selects two vectors having highest mutual association out of the group of vectors generated by the first group-of-vectors generating means or the group of vectors generated by the second group-of-vectors generating means.

According to this, the vectors having the highest association can be reliably brought near to each other, and thus, quantitative objectivity of vector arrangement can be ensured.

(8) In the technical document attribute association analysis supporting apparatus, it is preferable that

the first vector arranging means further comprises:
first cluster enlargement stopping determination means for stopping selection of the additional vector and enlargement of the cluster by the first cluster enlarging means when any association between end vectors positioned at both ends, out of the group of vectors configuring the cluster generated by the first cluster generating means, and the vectors other than the cluster, out of the group of vectors generated by the first group-of-vectors generating means, is equal to or less than a predetermined threshold value;
first new cluster generating means for selecting two vectors out of the vectors other than the cluster generated by the first cluster generating means based on a predetermined criterion and bringing the two vectors next to each other to generate a new cluster; and
first new cluster enlarging means for successively enlarging the new cluster by: selecting, as an additional vector, a vector having highest association with either one of end vectors positioned at both ends, out of the group of vectors configuring the new cluster generated by the first new cluster generating means, from the vectors other than the new cluster and other than the cluster generated by the first cluster generating means out of the group of vectors generated by the first group-of-vectors generating means; and bringing the additional vector next to an end vector which is determined to have the highest association with the additional vector to thereby add the additional vector to the new cluster; and/or

the second vector arranging means further comprises:
second cluster enlargement stopping determination means for stopping selection of the additional vector and enlargement of the cluster by the second cluster enlarging means when any association between end vectors positioned at both ends, out of the group of vectors configuring the cluster generated by the second cluster generating means, and the vectors other than the cluster, out of the group of vectors generated by the second group-of-vectors generating means, is equal to or less than a predetermined threshold value;
second new cluster generating means for selecting two vectors out of the vectors other than the cluster generated by the second cluster generating means based on a predetermined criterion and bringing the two vectors next to each other to generate a new cluster; and
second new cluster enlarging means for successively enlarging the new cluster by: selecting, as an additional vector, a vector having highest association with either one of end vectors positioned at both ends, out of the group of vectors configuring the new cluster generated by the second new cluster generating means, from the vectors other than the new cluster and other than the cluster generated by the second cluster generating means out of the group of vectors generated by the second group-of-vectors generating means; and bringing the additional vector next to an end vector which is determined to have the highest association with the additional vector to thereby add the additional vector to the new cluster.

According to this, when the association with the end vectors is equal to or less than the predetermined threshold value, forcibly grouping the vectors together into one cluster is avoided, and a combination of the vectors which have higher association can be prioritized. As a result, a confidence in arrangement of vectors can be improved. For the threshold value of the association, a coefficient of correlation at 0 is used, for example.

(9) It is preferable that the technical document attribute association analysis supporting apparatus further comprises:

display means for displaying a distribution state of scores arranged in a matrix manner based on arrangement by the first vector arranging means and the second vector arranging means by adding a pattern or a color corresponding to the scores.

When the distribution of scores is indicated by a numerical value only, the distribution state is not clear at a first glance. However, the addition of the pattern or the color enables the distribution state of the scores to be displayed in a more recognizable manner.

(10) Furthermore, the present invention includes a technical document attribute association analysis supporting method, provided with the same process as a method executed by each of the apparatuses, and a technical document attribute association analysis supporting program of a capable of causing a computer to execute the same process as the process executed by each of the apparatuses. The program may be recorded in a recording medium such as an FD, a CD-ROM, and a DVD, or may be transmitted and received via a network.

### BRIEF DESCRIPTION OF THE DRAWINGS

FIG. 1 is a diagram showing a hardware configuration of a technical document attribute association analysis supporting apparatus according to a first embodiment of the present invention.

FIG. 2 is a flowchart showing an operation procedure of a processing device 1, in the association analysis supporting apparatus according to the first embodiment.

FIG. 3 is a diagram showing a display example, by a display unit.

FIG. 4 is a diagram showing another display example, by the display unit.

FIGS. 5A and 5B are flowcharts for showing an operation procedure of a processing device 1 in an association analysis supporting apparatus according to a second embodiment.

FIG. 6 is an example of a document number matrix, generated in the second embodiment.

### DESCRIPTION OF NUMERICAL SYMBOLS

1 Processing device
2 Input device
3 Recording device
4 Output device
110 Data acquiring unit
120 Score calculating unit
130 and 140 First and second group-of-vectors generating units
150 and 160 First and second vector association calculating units
170 and 180 First and second vector arranging units

### BEST MODE FOR CARRYING OUT THE INVENTION

With reference to drawings, embodiments of the present invention are described in detail below.

### 1. DESCRIPTION OF ABBREVIATIONS, ETC

i: A technical document number assigned to each technical document. For example, the number is assigned to each of all patent applications extracted under a certain condition. A sequence of i=1, 2, . . . , N is given, where N represents the number of technical documents.

X, Y: Attributes of each technical document. For example, attributes include an applicant, a technical field (keyword or IPC), etc.

Xⱼ, Yₖ: Values of attributes. For example, these values denote a specific name of the applicant or the technical field, and are not limited to those expressed by a number.

σₖⱼ: Scores calculated by each combination of the attribute X and the attribute Y. Therefore, p×q of scores σₖⱼ can be defined, where a range of value of the attribute X is X₁, X₂, . . . , Xₚ, and that of the attribute Y is Y₁, Y₂, . . . , Y_{q}. These scores can be arranged in q rows and p columns in a matrix manner. In this case, a vector Xⱼ is a q-dimensional vector of which components are scores σ₁ⱼ, σ₂ⱼ, . . . , σ_{qj} belonging to the respective columns in a matrix manner arrangement, and a vector Yₖ is a p-dimensional vector of which components are scores σₖ₁, σₖ₂, . . . , σₖₚ belonging to the respective rows arranged in the same manner (in which the same symbols as those of the corresponding attribute values Xⱼ and Yₖ are used).

### 2. CONFIGURATION OF TECHNICAL DOCUMENT ATTRIBUTE ASSOCIATION ANALYSIS SUPPORTING APPARATUS

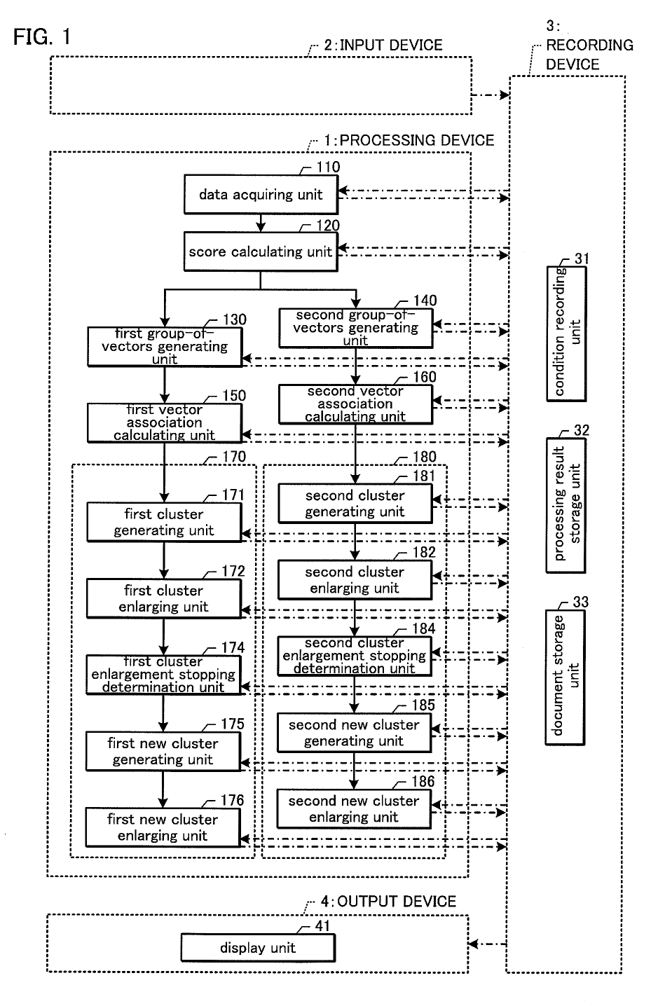

FIG. 1 is a diagram showing a hardware configuration of a technical document attribute association analysis supporting apparatus according to a first embodiment of the present invention. As shown in the figure, the association analysis supporting apparatus of the embodiment includes: a processing device 1 including a CPU (central processing unit), a memory (recording device), etc.; an input device 2 which is input means, such as a keyboard (manual input instrument); a recording device 3 which is recording means for storing data of a group of technical documents, conditions thereof, task results of the processing device 1, etc.; and an output device 4 which is an output means for displaying or printing and so on scores arranged in a matrix manner, etc.

The processing device 1 is provided with a data acquiring unit 110; a score calculating unit 120; first and second group-of-vectors generating units 130 and 140; first and second vector association calculating units 150 and 160; and first and second vector arranging units 170 and 180.

The recording device 3 includes: a condition recording unit 31; a processing result storage unit 32; a document storage unit 33. The document storage unit 33 includes data of a group of technical documents, obtained from an external database or an internal database. The external database means IPDL of Industrial Property Digital Library of which services are offered by Japan Patent Office, PATOLIS (registered trademark) of which serves are offered by PATOLIS Corporation, etc., for example. The internal database includes: a database on which data is independently stored, for example such as commercially available patent JP-ROM; a reader for reading from a medium such as an FD (flexible disk), a CD (compact disk) ROM, an MO (magnetooptical disk), a DVD (digital video disk), each of which contains documents; a device such as an OCR (optical character reader) for reading a document outputted to paper or the like or a hand-writing document; and a device for converting read data into electric data such as text.

In the embodiment, the technical document mainly includes, but is not limited to, patent publications. General technical documents such as a utility model publication, a technical paper, a magazine which covers technology, a book, can be analyzed.

For communicating means for exchanging a signal or data among the processing device 1, the input device 2, the recording device 3, and the output device 4: these components may be directly connected by a USB (universal system bus) cable, etc.; the signal or data may be transmitted and received via a network such as a LAN (local area network); or may be via a medium such as an FD, a CD-ROM, an MO, a DVD, each of which contains a document. Alternatively, a part of or some of these may be combined.

### 2-1. DETAIL OF THE INPUT DEVICE 2

A configuration and a function in the above-described association analysis supporting apparatus, is described in detail.

The input device 2 accepts input such as an acquiring condition of data of a group of technical documents, a calculation condition of scores, a generation condition of vectors, a calculation condition of association, an arrangement condition of vectors. These inputted conditions are sent to the condition recording unit 31 of the recording device 3, and stored therein.

### 2-2. DETAIL OF THE PROCESSING DEVICE 1

According to the acquiring condition of data inputted in the input device 2, the data acquiring unit 110 acquires the data of a group of technical documents to be analyzed, from the document storage unit 33 of the recording device 3. For example, based on bibliographical information, etc., of each technical document, at least two attributes of each technical document are acquired as the data. The acquired data of a group of technical documents is directly sent to the score calculating unit 120 and used for a process performed therein, or sent to the processing result storage unit 32 of the recording device 3 and stored therein.

Based on the data of a group of technical documents, which is acquired in the data acquiring unit 110, the score calculating unit 120 calculates scores σₖⱼ which correspond to the data of a technical document belonging to each combination of a first attribute X and a second attribute Y, out of the at least two attributes. The scores σₖⱼ are calculated by each combination of a value of the first attribute X and that of the second attribute Y. The calculated scores σₖⱼ are directly sent to the first and second group-of-vectors generating units 130 and 140 and used for a process therein, or sent to the processing result storage unit 32 of the recording device 3 and stored therein.

The first group-of-vectors generating unit 130 generates a group of vectors Xⱼ based on the scores σₖⱼ calculated in the score calculating unit 120. The group of vectors Xⱼ is calculated based on the scores belonging to each “column” in a matrix manner arrangement when the scores σₖⱼ are arranged in the matrix manner in which the first attribute X is located on a horizontal axis and the second attribute Y is located on a vertical axis.

The second group-of-vectors generating unit 140 generates a group of vectors Yₖ based on the scores σₖⱼ calculated in the score calculating unit 120. The group of vectors Yₖ is calculated based on the scores belonging to each “row” in a matrix manner arrangement when the scores σₖⱼ are arranged in the matrix manner in which the first attribute X is located on a horizontal axis and the second attribute Y is located on a vertical axis.

The groups of vectors Xⱼ and Yₖ generated by the first and second group-of-vectors generating units 130 and 140 are directly sent to the first and second vector association calculating units 150 and 160, respectively, and are used for a process therein, or sent to the processing result storage unit 32 of the recording device 3, and stored therein.

The first vector association calculating unit 150 calculates mutual association with respect to the group of vectors Xⱼ generated by the first group-of-vectors generating unit 130.

The second vector association calculating unit 160 calculates mutual association with respect to the group of vectors Yₖ generated by the second group-of-vectors generating unit 140.

Data of the association calculated in the first and second vector association calculating units 150 and 160 are directly sent to first and second vector arranging units 170 and 180 and used for a process therein, or sent to the processing result storage unit 32 of the recording device 3 and stored therein.

The first vector arranging unit 170 performs a process for arranging vectors having higher association to closer to one another based on the mutual association of the vectors Xⱼ calculated by the first vector association calculating unit 150.

The second vector arranging unit 180 performs a process for arranging vectors having higher association to closer to one another based on the mutual association of the vectors Yₖ calculated by the second vector association calculating unit 160.

The arrangement of the vectors determined in the first and second vector arranging units 170 and 180 is sent to the processing result storage unit 32 of the recording device 3 and stored therein, and is outputted by the output device 4 as necessary.

As a particularly preferable mode of the first and second vector arranging units 170 and 180, FIG. 1 shows configurations each provided with first and second cluster generating units 171 and 180, and first and second cluster enlarging units 172 and 182. As a further preferable mode, FIG. 1 shows configurations each provided with first and second cluster enlargement stopping determination units 174 and 184, first and second new cluster generating units 175 and 185, and first and second new cluster enlarging units 176 and 186.

The first cluster generating unit 171 selects two vectors out of the group of vectors generated by the first group-of-vectors generating unit 130 according to a predetermined criterion, and brings the two vectors next to each other to generate a cluster.

The second cluster generating unit 181 selects two vectors out of the group of vectors generated by the second group-of-vectors generating unit 140 according to a predetermined criterion, and brings the two vectors next to each other to generate a cluster.

As the predetermined criteria for selecting the two vectors, height of the association, for example, is used. Two vectors which have the highest mutual association may be selected.

The clusters generated by the first and second cluster generating units 171 and 181 are directly sent to the first and second cluster enlarging units 172 and 182, respectively, and used for a process therein, or sent to the processing result storage unit 32 of the recording device 3 and stored therein.

The first cluster enlarging unit 172 adds an additional vector to the cluster generated in the first cluster generating unit 171 to successively enlarge the cluster generated in the first cluster generating unit 171. The additional vector is determined by selecting a vector which has highest association with either one of the end vectors positioned at both ends, out of the group of vectors which configures the cluster generated by the first cluster generating unit 171 from the group of vectors other than the above-described cluster out of the group of vectors Xⱼ generated by the first group-of-vectors generating unit 130. The addition of the additional vector to the cluster is performed by bringing the additional vector next to the end vector which is determined to have the highest association with the additional vector. However, in addition to this, the additional vector may be added in another location within the cluster.

The second cluster enlarging unit 182 adds an additional vector to the cluster generated in the second cluster generating unit 181 to successively enlarge the cluster generated in the second cluster generating unit 181. The additional vector is determined by selecting a vector which has highest association with either one of the end vectors positioned at both ends, out of the group of vectors which configures the cluster generated by the second cluster generating unit 181 from the group of vectors other than the above-described cluster out of the group of vectors Yₖ generated by the second group-of-vectors generating unit 140. The addition of the additional vector to the cluster is performed by bringing the additional vector next to the end vector which is determined to have the highest association with the additional vector. However, in addition to this, the additional vector may be added in another location within the cluster.

The clusters are enlarged by the first and second cluster enlarging units 172 and 182, and when there are no more vectors which are not added to the cluster, processes of the first and second vector arranging units 170 and 180 are ended.

The first cluster enlargement stopping determination unit 174 stops the selection of the additional vector and the enlargement of the cluster by the first cluster enlarging unit 172 when any association between the end vectors positioned at both ends, out of the group of vectors which configures the cluster generated by the first cluster generating unit 171 and the vectors other than the above-described cluster, out of the group of vectors Xⱼ generated by the first group-of-vectors generating unit 130 is equal to or less than a predetermined threshold value.

The second cluster enlargement stopping determination unit 184 stops the selection of the additional vector and the enlargement of the cluster by the second cluster enlarging unit 182 when any association between the end vectors positioned at both ends, out of the group of vectors which configures the cluster generated by the second cluster generating unit 181 and the vectors other than the above-described cluster out of the group of vectors Yₖ generated by second group-of-vectors generating unit 140 is equal to or less than a predetermined threshold value.

It is desired that if a coefficient of correlation is employed, for example, the predetermined threshold value is set to 0 (uncorrelated).

The first new cluster generating unit 175 selects two vectors out of the vectors other than the cluster (in the case where the cluster is enlarged by the first cluster enlarging unit 172, the enlarged cluster) generated by the first cluster generating unit 171 according to a predetermined criterion, and brings the two vectors next to each other to generate a new cluster.

The second new cluster generating unit 185 selects two vectors out of the vectors other than the cluster (in the case where the cluster is enlarged by the second cluster enlarging unit 182, the enlarged cluster) generated by the second cluster generating unit 181 according to a predetermined criterion, and brings the two vectors next to each other to generate a new cluster.

The new clusters generated by the first and second new cluster generating units 175 and 185 are directly sent to the first and second new cluster enlarging units 176 and 186, respectively, and used for a process therein, or sent to the processing result storage unit 32 of the recording device 3 and stored therein.

The first new cluster enlarging unit 176 adds the additional vector to the new cluster generated in the first new cluster generating unit 175, to successively enlarge the new cluster. The additional vector is determined by selecting a vector which has highest association with either one of the end vectors positioned at both ends of the above-described new cluster generated by the first new cluster generating unit 175 from the vectors other than the above-described new cluster and other than the cluster generated by the first cluster generating unit 171 out of the group of vectors Xⱼ generated by the first group-of-vectors generating unit 130. The addition of the additional vector to the new cluster is performed by bringing the additional vector next to the end vector which is determined to have the highest association with the additional vector.

The second new cluster enlarging unit 186 adds the additional vector to the new cluster generated in the second new cluster generating unit 185, to successively enlarge the new cluster. The additional vector is determined by selecting a vector which has highest association with either one of the end vectors positioned at both ends of the above-described new cluster generated by the second new cluster generating unit 185 from the vectors other than the above-described new cluster and other than the cluster generated by the second cluster generating unit 181 out of the group of vectors Yₖ generated by the second group-of-vectors generating unit 140. The addition of the additional vector to the new cluster is performed by bringing the additional vector next to the end vector which is determined to have the highest association with the additional vector.

The new clusters are enlarged by the first and second new cluster enlarging units 176 and 186 and when there are no vectors other than the clusters, processes of the first and second vector arranging units 170 and 180 are ended.

### 2-3. DETAIL OF THE RECORDING DEVICE 3

In the recording device 3, the condition recording unit 31 records information such as a condition obtained from the input device 2, and sends necessary data according to a request of the processing device 1. The processing result storage unit 32 stores a task result of each configurational element in the processing device 1, and sends necessary data based on the request of the processing device 1. The document storage unit 33 stores and provides necessary data of the group of technical documents, which is obtained from the external database or the internal database based on the request of the input device 2 or the processing device 1.

### 2-4. DETAIL OF THE OUTPUT DEVICE 4

The output device 4 outputs the scores arranged in a matrix manner, etc., based on the arrangement of the vectors determined by the first and second vector arranging units 170 and 180 of the processing device 1. The output device 4 is provided with a display unit 41 such as a display device, for example, which displays a distribution state of the scores arranged in a matrix manner by adding a pattern or a color corresponding to the score. Examples of output modes may not be limited to a display on the display unit 41 but include printing on a print medium such as paper, transmission to a computer device on a network via communication means, and so on.

### 3. OPERATION OF THE FIRST EMBODIMENT

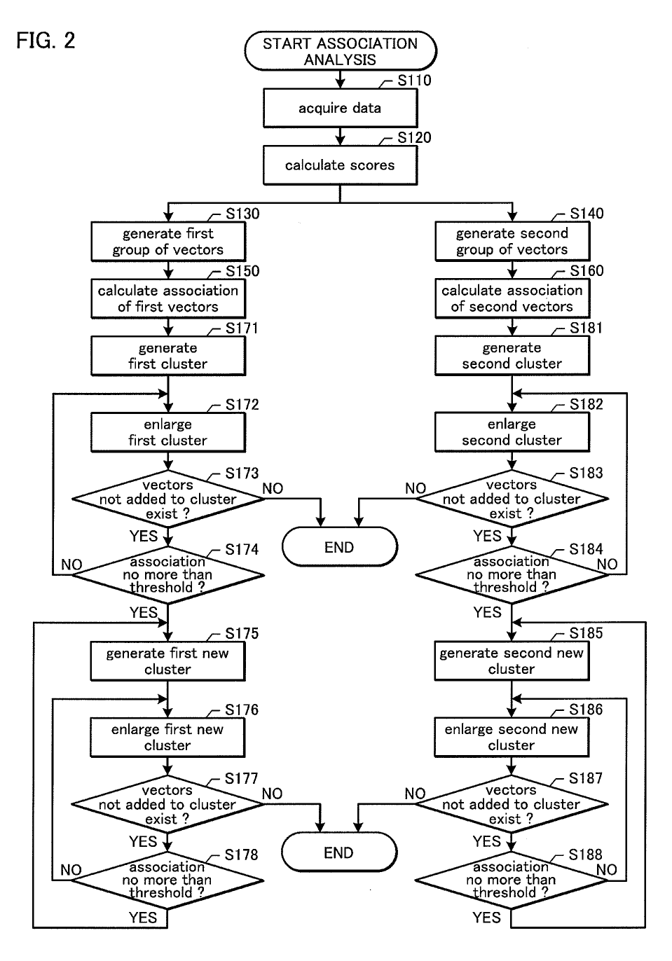

FIG. 2 is a flowchart showing an operation procedure of the processing device 1 in the association analysis supporting apparatus according to the first embodiment.

### 3-1. DATA ACQUISITION OF GROUP OF TECHNICAL DOCUMENTS

Firstly, in the data acquiring unit 110, the data of a group of technical documents to be analyzed is acquired (step S110). Each document in the group of technical documents needs to have at least two attributes, i.e., the attributes X and Y. The number of documents in the group of technical documents is set to N. For example, data as shown in the following [Table 1] is obtained. The number of values of attributes in each technical document may be one, or that of values of the attributes in each technical document may be plural, as shown in an attribute Z of technical document numbers 2, 3, 4, etc., in the following [Table 1]. For example, when a plurality of inventors are described in one patent document, this means that there are the values of inventor attributes as the number of inventors.

TABLE 1

| Technical | Attribute | Attribute | | Attribute |
|---|---|---|---|---|
| Document No. i | X | Y | . . . | Z |
| 1 | X₁ | Y₁ | | Z₁ |
| 2 | X₁ | Y₃ | | Z₂ Z₄ |
| 3 | X₁ | Y₃ | | Z₁ Z₂ |
| 4 | X₁ | Y₄ | | Z₂ Z₃ |
| 5 | X₁ | Y₅ | | Z₃ |
| 6 | X₂ | Y₁ | | Z₄ |
| 7 | X₂ | y₁ | | Z₃ Z₄ |
| 8 | X₂ | Y₄ | | Z₄ |
| 9 | X₂ | Y₆ | | Z₅ |
| 10 | X₃ | Y₂ | | Z₅ |
| . | | | | |
| . | | | | |
| . | | | | |
| N | X₄ | Y₁ | | Z₁ Z₃ |

### 3-2. CALCULATION OF SCORES

Subsequently, the score calculating unit 120 calculates scores which correspond to the data of the technical documents belonging to each combination of the first attribute X and the second attribute Y out of the above-described at least two attributes (step S120).

For this purpose, two types (for example, an “applicant” and a “keyword”. These are referred to as X and Y, respectively, in the following description of the embodiment) out of the attributes are firstly selected. This selection is performed based on an instruction of a user, which is inputted from the input device 2. It is preferable that one of the two attributes be a person attribute such as an applicant, an inventor, and the other thereof be a technical field attribute such as a keyword, IPC. Further, it may be possible that the both of the two attributes are technical field attributes, in which one of these is a technical classification and the other thereof is a technical element, for example. Alternatively, for either one of or both of the two attributes, an attribute such as an application date which is not a person attribute nor a technical field attribute may be selected.

When the two attributes are selected, with respect to each attribute X or Y, a range (range of value) of an attribute value Xⱼ or Yₖ (which indicates a specific name of the applicant or the keyword, for example, and is not limited to a numerical value) is determined. For example, firstly, a descending ranking of the number of the technical documents as shown in the following [Table 2] is created. In this ranking, with respect to the attribute X, a range within which top p of values are present, and with respect to the attribute Y, a range within which top q of values are present are set to a range of value for each attribute. The number p of values Xⱼ within the range of value of the attribute X and the number q of values Yₖ within the range of value of the attribute Y may be the same or may be different. For example, the range of value may be selected according to analysis purposes such as several top companies with a large number of values or technical fields to be analyzed. The following description is made on the assumption that with respect to the attribute X, values X₁, X₂, . . . , Xₚ are determined as the range of value, and with respect to the attribute Y, values Y₁, Y₂, . . . , Y_{q} are determined as the range of value.

TABLE 2

| | The Number of | | The Number of |
|---|---|---|---|
| | Technical | | Technical |
| Attribute X | Documents | Attribute Y | Documents |
| X₁ | 10 | Y₁ | 11 |
| X₂ | 10 | Y₂ | 8 |
| X₃ | 6 | Y₃ | 7 |
| X₄ | 3 | Y₄ | 4 |
| . | . | . | . |
| . | . | . | . |
| . | . | . | . |
| Xₚ | 2 | Y_{q} | 2 |
| . | . | . | . |
| . | . | . | . |
| . | . | . | . |
| Total Number | N | Total Number | N |
| of Technical | | of Technical | |
| Documents | | Documents | |

Subsequently, with respect to each combination of the attribute values Xⱼ and Yₖ (it is noted that j=1, 2, . . . , p, and k=1, 2, . . . , q), p×q of scores σₖⱼ are calculated based on the number of documents of technical documents having combinations of these attribute values.

The scores σₖⱼ may be set to the number of documents itself of technical documents having the same combinations of the attribute values Xⱼ and Yₖ (Xⱼ, Yₖ), or may be set to a function value in which the number of documents is a variable, obtained as a result of a normalization process and so on. When the scores σₖⱼ are set to the number of documents itself, in the case where the number of technical documents having a set of attribute values (X₁, Y₁) is a technical document number i=1 only out of N of technical documents, as shown in the above-described [Table 1], for example, a score σ₁₁ with respect to the set of (X₁, Y₁) is 1. When the number of technical documents having a set of attributes (X₁, Y₃) is two, i.e., technical document numbers i=2 and i=3, out of N of technical documents, as shown in the above-described [Table 1], for example, a score σ₃₁ with respect to the sets of (X₁, Y₃) is set to 2. The scores σₖⱼ may be represented as shown in the following [Table 3], for example. Hereinafter, a hypothetical example represented in this [Table 3] is appropriately referred.

TABLE 3

| | | Xⱼ | | | | | |
|---|---|---|---|---|---|---|---|
| σₖⱼ | | X₁ | X₂ | X₃ | X₄ | X₅ | X₆ |
| Yₖ | Y₁ | σ₁₁ = 1 | σ₁₂ = 8 | σ₁₃ = 0 | σ₁₄ = 1 | σ₁₅ = 0 | σ₁₆ = 1 |
| | Y₂ | σ₂₁ = 0 | σ₂₂ = 0 | σ₂₃ = 5 | σ₂₄ = 2 | σ₂₅ = 1 | σ₂₆ = 0 |
| | Y₃ | σ₃₁ = 6 | σ₃₂ = 0 | σ₃₃ = 0 | σ₃₄ = 0 | σ₃₅ = 1 | σ₃₆ = 0 |
| | Y₄ | σ₄₁ = 2 | σ₄₂ = 1 | σ₄₃ = 0 | σ₄₄ = 0 | σ₄₅ = 1 | σ₄₆ = 0 |
| | Y₅ | σ₅₁ = 1 | σ₅₂ = 0 | σ₅₃ = 1 | σ₅₄ = 0 | σ₅₅ = 0 | σ₅₆ = 0 |
| | Y₆ | σ₆₁ = 0 | σ₆₂ = 1 | σ₆₃ = 0 | σ₆₄ = 0 | σ₆₅ = 0 | σ₆₆ = 1 |

In this way, as there are p×q of combinations of attribute values in this way, p×q of scores σₖⱼ (j=1, 2, . . . , p, k=1, 2, . . . , q) can be arranged in q rows and p columns in a matrix manner. In an example of [Table 3], there are six rows and six columns.

When the range of value of the attribute X or Y is large, and thus, p or q is too large, a certain width is provided and the attribute values are reset, and in this state, the scores σₖⱼ may be determined. For example, when the application date is selected as the attribute X, the value of p exceeds 1000 in several years if no modification is made. To solve this problem, a year of application or a year and a month of application may be set as the attribute value. As a result, the range of value of the attributes can be reduced to a size easier to be analyzed.

In this case, a description is give of an example in which the scores σₖⱼ are calculated based on the number of documents. However, a method of calculation is not limited thereto, and weighting αᵢ (i=1, 2, . . . , N) is applied to each technical document, and the weighting may be reflected in the calculation of the scores. For example, each combination of the attribute values Xⱼ and Yₖ may be calculated by:

σₖⱼ=Σαᵢ∀iε(Xⱼ,Yₖ)

That is, with respect to all symbols i of which combinations of attribute values are (Xⱼ, Yₖ), a sum of weightings αᵢ may be the scores σₖⱼ. For example, as shown in the above-described [Table 1], the number of technical documents having a set of attributes (X₁, Y₃) is two out of N of technical documents, i.e., technical document numbers i=2 and i=3. When weightings α₂ and α₃ are imparted, respectively, a score α₃₁ with respect to the set of (X₁, Y₃) is α₂+α₃.

In the case of a patent document, with respect to the weighting αᵢ in this case, it is preferable that a large value be imparted when a patent registration is completed and otherwise, a small value is imparted, for example, i.e., the value is imparted based on prosecution history information, or based on the number of independent claims or the number of times of citations, etc.

When the scores σₖⱼ are represented by the number of documents (when the same weighting αᵢ=1 is imparted to every technical document), there is an advantage in that a distribution of attributes can be simply and objectively expressed.

On the other hand, when the value of separate weightings αᵢ is applied to each technical document and the weightings αᵢ are totaled to calculate the scores σₖⱼ, appropriate analysis is enabled by using scores to which importance or a quality element of a technical document is added.

### 3-3. GENERATION OF VECTORS

Subsequently, in the first and second group-of-vectors generating units 130 and 140, vectors are generated (steps S130 and S140).

More specifically, the q-dimensional vector of which components are scores σ₁ⱼ, σ₂ⱼ, . . . , σ_{qj} belonging to each column when the scores are arranged in q rows and p columns in a matrix manner, as described above, is the vector Xⱼ (j=1, 2, . . . , p). This vector Xⱼ shows a distribution of the attribute Y with respect to the value Xⱼ of the attribute X. For example, the vector Xⱼ shows a distribution of technical fields with respect to a patent application of a certain company Xⱼ. In the hypothetical example in the above-described [Table 3], an applicant X₁ files many patent applications in technical fields Y₃ and Y₄, but does not file an application in technical fields Y₂ and Y₆.

Similarly, the p-dimensional vector of which components are scores σₖ₁, σₖ₂, . . . σₖₚ belonging to each row when arranged in a matrix manner, as described above, is the vector Yₖ (k=1, 2, . . . , q). This vector Yₖ shows a distribution of the attributes X with respect to the value Yₖ of the attribute Y. For example, the vector Yₖ shows a distribution of applicants with respect to a certain technical field Yₖ. In the hypothetical example in the above-described [Table 3], in the technical field Y₁, an applicant X₂ files many patent applications, but other applicants do not file many patent applications.

In the vectors Xⱼ and Yₖ, the scores by themselves may be components, as described above, but logarithms of scores σₖⱼ may desirably be components. The reason for this is because the scores σₖⱼ based on the combination of the two technical document attributes are non-negative and tend to concentrate adjacent to 0. When the logarithms of the scores σₖⱼ are the components in such a case, the distribution of the vector components is close to a normal distribution, and thus, a degree of confidence of an association calculation result can be improved. In particular, when the coefficient of correlation is selected as a method of evaluating the association, it is desired that the logarithms of the scores σₖⱼ are the components.

When the score σₖⱼ is 0, the logarithm thereof cannot be defined. However, instead of taking a logarithm of 0, the score σₖⱼ may be set to −1 or another negative number for the sake of convenience, for example. Alternatively, 1 or another positive number may be added respectively to all the scores for the sake of convenience, and in this state, logarithms of these numbers may be taken.

A method of generating the vectors may include a method of using values obtained by multiplying the score by an inverse of an appearance frequency as the components, in addition to the method of using the scores as the components and the method of using the logarithms of the scores σₖⱼ as the components as described above.

For example, in the [Table 3], with respect to the value X₂ of the attribute X on one side, the score σₖ₂ appears three times in the range of value of the attribute Y, from Y₁ to Y₆ (it is noted that a score of σₖⱼ=0 is not counted in the number of times of appearances). Therefore, the scores σₖ₂ which correspond to the value X₂ are multiplied by ⅓ which is an inverse of the appearance frequency. Further, in the [Table 3], with respect to the value Y₁ of the attribute Y on the other side, the score σ₁ⱼ appears four times in the range of value of the attribute X, from X₁ to X₆. Therefore, the scores σ₁ⱼ which correspond to the value Y₁ are multiplied by ¼ which is an inverse of the appearance frequency. As a result, for example, the score σ₁₂=8 is multiplied by ⅓ which is the inverse of the appearance frequency in the value X₂ and ¼ which is the inverse of the appearance frequency in the value Y₁. Thus, a first component of the vector X₂ or a second component of the vector Y₁ (components which correspond to a combination of values (X₂, Y₁)) is 8/(3×4). When each score is multiplied by the inverse of the appearance frequency similarly in the case of other components, components as shown in [Table 4] are obtained. Vectors configured of components of columns each of which corresponds to the range of values X₁ to X₆ are the vectors X₁ to X₆, respectively; and vectors configured of components of rows each which corresponds to the range of values Y₁ to Y₆ are vectors Y₁ to Y₆, respectively.

TABLE 4

| | | | | | | | | Appearance |
|---|---|---|---|---|---|---|---|---|
| | | | | | | | | Frequency |
| | | Xⱼ | | | | | | in Each |
| | | X₁ | X₂ | X₃ | X₄ | X₅ | X₆ | Value Yₖ |
| Yₖ | Y₁ | 1/(4 × 4) | 8/(3 × 4) | 0 | 1/(2 × 4) | 0 | 1/(2 × 4) | 4 |
| | Y₂ | 0 | 0 | 5/(2 × 3) | 2/(2 × 3) | 1/(3 × 3) | 0 | 3 |
| | Y₃ | 6/(4 × 2) | 0 | 0 | 0 | 1/(3 × 2) | 0 | 2 |
| | Y₄ | 2/(4 × 3) | 1/(3 × 3) | 0 | 0 | 1/(3 × 3) | 0 | 3 |
| | Y₅ | 1/(4 × 2) | 0 | 1/(2 × 2) | 0 | 0 | 0 | 2 |
| | Y₆ | 0 | 1/(3 × 2) | 0 | 0 | 0 | 1/(2 × 2) | 2 |

| | | | | | | |
|---|---|---|---|---|---|---|
| Appearance | 4 | 3 | 2 | 2 | 3 | 2 |
| Frequency | | | | | | |
| in Each | | | | | | |
| Value Xⱼ | | | | | | |

In this way, when the value of the vector component which appears commonly in many vectors is set low, and the value of the vector component which appears only in a specific vector is set high. Thereby, it becomes possible to generate a vector in which the score unique to the value of each document attribute is emphasized.

### 3-4. CALCULATION OF ASSOCIATION

Subsequently, in the first and second vector association calculating units 150 and 160, mutual association of p of vectors Xⱼ and those of q of vectors Yₖ are calculated, respectively (steps S150 and S160).

For example, the mutual association of p of vectors Xⱼ in the hypothetical example in the [Table 3] are obtained as data as shown in the following [Table 5] using coefficients of correlation, for example.

TABLE 5

| | X₁ | X₂ | X₃ | X₄ | X₅ | X₆ |
|---|---|---|---|---|---|---|
| X₁ | 1 | −0.19 | −0.40 | −0.42 | 0.49 | −0.40 |
| X₂ | | 1 | −0.32 | 0.23 | −0.47 | 0.70 |
| X₃ | | | 1 | 0.84 | 0.37 | −0.39 |
| X₄ | | | | 1 | 0.22 | 0 |
| X₅ | | | | | 1 | −0.71 |
| X₆ | | | | | | 1 |

This table shows a calculation result of the association with respect to the vector Xⱼ which corresponds to the attribute X, but a calculation result of the association with respect to the attribute Y may be similarly shown. The method of evaluating the association may include a method of using a dot product, and a method of calculating Spearman's rank correlation coefficient, in addition to the method of using the coefficient of correlation.

### 3-5. ARRANGEMENT OF VECTORS

Subsequently, in the first and second vector arranging units 170 and 180, a process for arranging vectors which have high association closer to one another than those which have low association is performed. One of methods thereof is described below. Hereinafter, the description is made by mainly showing an example which relates to the attribute X, but the same may be applied to the attribute Y.

### 3-5-1. GENERATION OF CLUSTER

Firstly, in the first and second cluster generating units 171 and 181, two vectors are brought next to each other to generate a cluster (steps S171 and S181).

In one example of the method, out of p of vectors Xⱼ, two vectors which have the highest mutual association are selected, and these vectors are brought next to each other to generate the cluster. In the example of the above-described [Table 5], the vectors X₃ and X₄ which have a coefficient of correction of 0.84 have the highest association, and thus, these vectors are brought next to each other.

When the two vectors which have the highest association are selected to generate the cluster, vectors which have the highest association can be reliably brought next to each other, and thus, quantitative objectivity of vector arrangement can be ensured.

The selection of the vectors which are brought next to each other may be performed by another method. For example, when a specific applicant (a user's company, etc.) and the rest of the applicants are compared, a vector of the specific applicant and a vector which has highest association with the vector of applicant may be brought next to each other. Alternatively, for example, when specific two applicants (the user's company and a competitor thereof, etc.) are compared, and at the same time, these two applicants and the rest of the applicants are compared, the vectors of the specific two applicants may be brought next to each other.

Hereinafter, an aggregate of a plurality of vectors which are brought next to another vector are referred to as a “cluster”.

### 3-5-2. ENLARGEMENT OF CLUSTER

Subsequently, in the first and second cluster enlarging units 172 and 182, the additional vector is added to the cluster to enlarge the cluster (steps S172 and S182).

More specifically, between the vectors positioned at the both ends of the cluster and each of the remaining vectors which are not added to the cluster, a set of vectors which has the highest association is determined. In the above-described example, a vector which has the highest association with the vector X₃ or X₄ positioned at the both ends of the cluster is a vector X₅ of which a coefficient of correlation with the vector X₃ is 0.37. Therefore, the vector X₅ is determined as the additional vector.

After the determination of the set of vectors which have the highest association, the vectors are brought next to each other to form a larger cluster. In the above-described example, the additional vector X₅ is brought next to the vector X₃ which is one of the vectors X₃ and X₄ which are already brought next to each other. However, without limited to this, the additional vector may be added to another location within the cluster.

As described above, vectors which have higher association are successively brought next to each other to enlarge the cluster, and thereby, the vectors which have high association are reliably arranged closely. As a result, it becomes possible to form a distribution state in a manner that a state of concentration or dispersion of the data distribution of the document attributes is explicitly specified.

As a result of the cluster enlargement, when there are no more vectors which are not yet added to the cluster (steps S173 and S183: NO), the arrangement of the vectors is ended. When vectors remain which are not yet added to the cluster (steps S173 and S183: YES), the processes proceed to steps S174 and S184, respectively.

At the steps S174 and S184, in the first and second cluster enlargement stopping determination units 174 and 184, it is determined whether any association with vectors other than the cluster is equal to or less than a predetermined threshold value. When there is at least one association which exceeds the predetermined threshold value (steps S174 and S184: NO), the processes are returned to the steps S172 and S182, respectively, to successively enlarge the cluster.

For example, when it is assumed that a vector which has the highest association with X₅ or X₄ at both ends of a cluster which is formed by bringing the vectors X₅, X₃ and X₄ next to each other in this order is a vector X₁ of which a coefficient of correlation with the vector X₅ is 0.49, the additional vector X₁ is brought next to the vector X₅.

It may be possible to preliminarily decide which one of the vectors at both ends of the cluster the vector having high association therewith is brought next to. For example, when it is decided that a determination is made as to which vector has high association with only one of the both ends of the cluster to bring the vector next to the end of the cluster, vectors which firstly configure the cluster will be lastly arranged on an end of the matrix. Alternatively, for example, when it is decided that a determination is alternately made as to which vector has high association with one end of the cluster and with the other end thereof to bring the vector next to either end of the cluster, vectors which firstly configure the cluster will be lastly arranged in a center of the matrix.

### 3-5-3. GENERATION OF A NEW CLUSTER

At the steps S174 and S184, when any association is equal to or less than the predetermined threshold value (steps S174 and S184: YES), the processes proceed to steps S175 and S185.

At the steps S175 and S185, in the first and second new cluster generating units 175 and 185, out of the vectors other than the above-described cluster, two vectors are brought next to each other to generate a new cluster.

In the first and second new cluster enlarging units 176 and 186, the additional vector is added to the new cluster to enlarge the new cluster (steps S176 and S186).

That is, when there are no more vectors which have association equal to or more than the threshold value, the remaining vectors only are used to generate the new cluster, and a cluster enlarging procedure similar to that described above is repeated.

In this way, when the association with the vectors at both ends of the cluster are equal to or less than the predetermined threshold value, forcibly grouping the vectors together into one cluster is avoided, and a combination of vectors which have higher association is prioritized. As a result, the reliability of the arrangement of vectors can be improved.

It is desired for the threshold value of the association that a coefficient of correlation, for example, is set to 0 (uncorrelated). The use of the coefficient of correlation as the method of evaluating the association is advantageous in that the threshold value can be easily set.

As a result of enlargement of the new cluster, when there are no more vectors which are not yet added to the cluster (steps S177 and S187: NO), the arrangement of vectors is ended. When vectors remain which are not yet added to the cluster (steps S177 and S187: YES), the processes proceed to steps S178 and S188, respectively.

At the steps S178 and S188, it is determined whether any association with vectors other than the cluster are equal to or less than the predetermined threshold value. When there is at least one association which exceeds the predetermined threshold value (the steps S178 and S188: NO), the processes are returned to the steps S176 and S186, respectively, to successively enlarge the new cluster. When any association is equal to or less than the predetermined threshold value (the steps S178 and S188: YES), the processes are returned to the steps S175 and S185, respectively, to generate still another new cluster.

As a result of the above-described processes, a plurality of clusters are formed, and lastly these clusters are brought adjacent to one another. A method of bringing the clusters adjacent to one another may include a method in which clusters are arranged in one direction from one end to the other end, a method in which the clusters are arranged alternately from the both ends toward the center, etc., in descending or ascending order of size of the cluster (the number of vectors included in the cluster).

A similar procedure is performed not only for the attribute X but also for the attribute Y, and an arrangement determination is ended. The above-described example provides a result as shown in the following [Table 6].

TABLE 6

Xⱼ

| | | | | | | |
|---|---|---|---|---|---|---|
| σₖⱼ | X₁ | X₅ | X₃ | X₄ | X₂ | X₆ |

| | | | | | | | |
|---|---|---|---|---|---|---|---|
| Yₖ | Y₂ | 0 | 1 | 5 | 2 | 0 | 0 |
| | Y₅ | 1 | 0 | 1 | 0 | 0 | 0 |
| | Y₃ | 6 | 1 | 0 | 0 | 0 | 0 |
| | Y₄ | 2 | 1 | 0 | 0 | 1 | 0 |
| | Y₁ | 1 | 0 | 0 | 1 | 8 | 1 |
| | Y₆ | 0 | 0 | 0 | 0 | 1 | 1 |

After the score calculation at the step S120, with respect to the order of executing the processes in the first group-of-vectors generating unit 130, the first vector association calculating unit 150, and the first vector arranging unit 170 (the steps S130, S150, and S171 to S178) and the processes in the second group-of-vectors generating unit 140, the second vector association calculating unit 160, and the second vector arranging unit 180 (steps S140, S160, and S181 to S188), any one of the processes may be executed first, and the other may be executed later, or the both processes may be executed simultaneously and in parallel. Alternatively, only any one of the processes may be executed. The execution of only one of the processes may be applied to a case where when one attribute X is a person attribute such as an applicant and the other attribute Y is a technical classification by a code system such as IPC, the attribute Y becomes easier to see when it is arranged according to the order of systematized code number, without performing the arrangement based on the association, for example.

### 3-6. OUTPUT EXAMPLE

Output by the output device 4 may be performed in a mode as shown in [Table 6]. For better visibility, a pattern or a color may be added to the distribution state of the scores according to the scores for display. For example, it is preferable that a deep color or a warm color be added to an area where high scores are distributed, and a light color or a cool color be added to an area where low scores are distributed. It is probable that when the distribution of the scores is shown by a numerical value only, the distribution state is not immediately obvious, but when the pattern or the color is added, the distribution state of the score can be displayed in a manner that is easy to see.

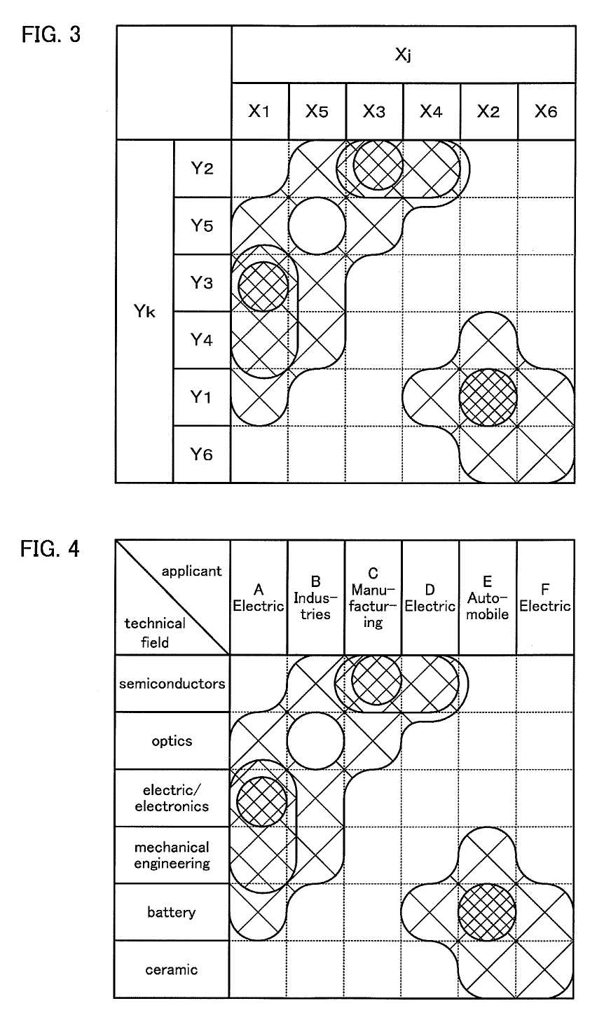

FIG. 3 is a diagram showing one display example by the display unit. In the figure, a densely distributed area is added with lattice diagonal lines of which a linear density is high, and a roughly distributed area is added lattice diagonal lines of which a linear density is low. As shown in the figure, when the distribution state of scores is indicated by a so-called cloud map or a contour line map, whether the distribution state of score is dense or rough becomes clear, and thus, the distribution state of scores can be displayed in a more recognizable manner.

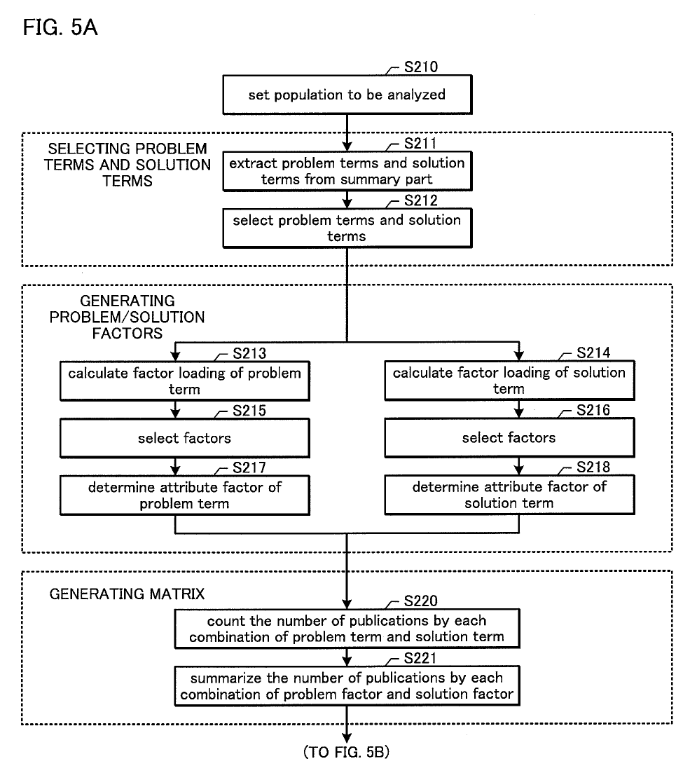

FIG. 4 is a diagram showing another display example by the display unit. In the figure, a value of each of attributes is specifically shown, in which an “applicant” is selected as the first attribute X and a “technical field” is selected as the second attribute Y. In this figure also, the densely distributed area is added with the lattice diagonal lines of which a linear density is high, and the roughly distributed area is added with the lattice diagonal lines of which a linear density is low, and thus, whether the distribution state of score is dense or rough becomes clear. That is, when a specific “applicant” is selected and a densely distributed location is seen, a main technical field developed by the applicant can be read, and when a specific “technical field” is selected and a densely distributed location is seen, a main applicant who develops in the technical field can be read.

When the person attribute and the technical field attribute are used, as shown in FIG. 4, the following analysis is enabled.

An association of a technical development area between the user's company and another company is shown, and therefore:

(a) A company which has a similar development orientation can be searched. In FIG. 4, “E automobile” is the user's company, for example, “F electric” which is next thereto can be discovered. The company which is discovered here is not limited to a company which currently competes with the user's company in a marketplace. When “F electric” which is compared with the user's company “E automobile” has a development orientation such as “battery”, and “ceramic”, similar to that of the user's company and which has already entered an industry in which the user's company has not yet entered (an electric-related product, for example), it is anticipated that a technical barrier against which the user' company needs to overcome to newly enter the industry is low.

(b) It is possible to discover a strength/weakness in a development orientation of the user's company as compared to a company which competes with the user's company in the marketplace but has a different development orientation. In FIG. 4, when it is assumed that the user's company is “D electric” which performs well in “semiconductors” but does not perform well in “electric/electronics”, for example, by comparing with “A electric” which has a different development orientation, performs well in “electric/electronics”, and does not perform well in “semiconductors”, it becomes possible to discover the strength/weakness in the development sector of the user's company.

(c) It is possible to search a technology partner which has a different development orientation and which can reciprocally compensate the weakness of the development sector. In FIG. 4, when it is assumed that the user's company is “C manufacturing” which is exclusively dedicated to “semiconductors” and “optics” and which has no other strong field, for example, it is possible to discover “A electric”, etc., which has a different development orientation and which performs well in “electric/electronics”, etc.

An association of a developer between a certain technical field and another technical field is shown, and thus, it is also possible to analyze association between the technical fields. For example, in the case where there is a high tendency that the same company “E automobile” or “F electric” handles the technical fields to be compared as in the case of “battery” and “ceramic” next to each other in FIG. 4, the following may apply:

(a) It is possible to find out a possibility that the handling of the both fields has led to the current business so as to determine a potential for entering such a business or to determine a necessity of further technical development for entering such a business, or

(b) It is possible to find out a possibility of mutual conversion of these technical fields in spite of lacking technical relationship at one view.

In FIG. 4, the description is given on the example in which one of the two attributes is the person attribute and the other is the technical field attribute, but in addition thereto, it may be possible that both of the two attributes are the technical field attributes, and in this case, one of attributes may be a technical classification and the other may be a technical element. Further, one of these may be an IPC main classification (section, class), and the other may be an IPC sub classification (group, subgroup), etc.

As described above, according to the embodiment, a company on its own becomes capable of grasping a technical development achievement developed by a company's own research and development organization or the current status of the technical asset portfolio so as to obtain an objective guideline for the direction of development in the future, thereby supporting investment decisions in company technical development.

Also, as described above, when a technique of the present invention is applied to various combinations of the technical document attributes, it becomes possible to accurately analyze the current status of a development system of a specific company from more multiple points, and further, based on the result obtained by the analysis, it becomes possible to more effectively support company decision making for the direction of development in the future.

### 4. SECOND EMBODIMENT

Next, a second embodiment of the present invention is described. A hardware configuration of a technical document attribute association analysis supporting apparatus according to the second embodiment is the same as that (FIG. 1) in the first embodiment, and thus, the description is omitted.

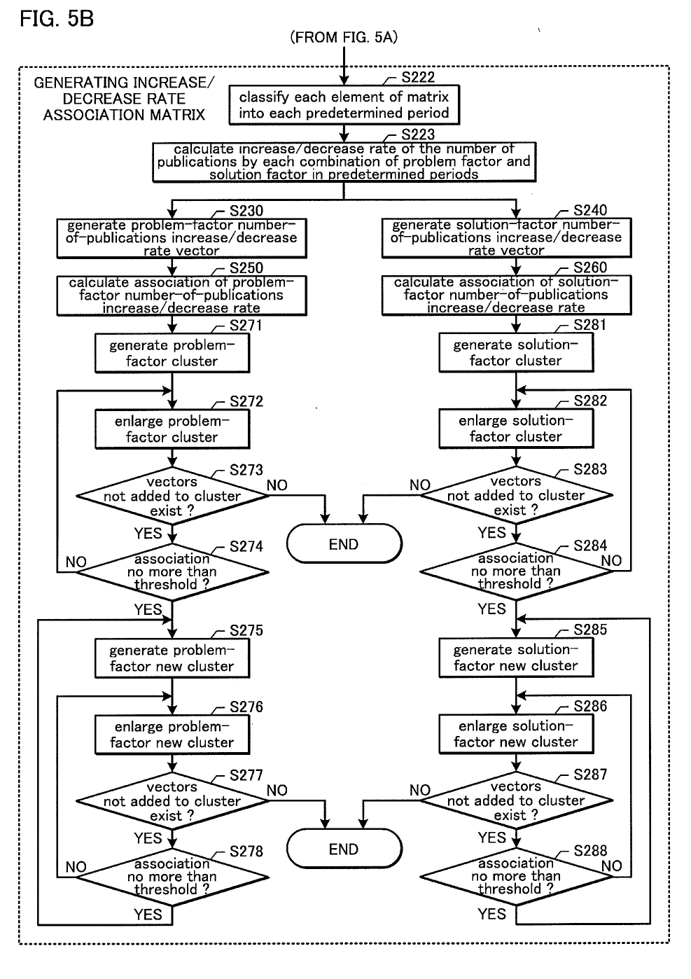

FIGS. 5A and 5B are flowcharts showing an operation procedure of the processing device 1 in the association analysis supporting apparatus of the second embodiment.

The second embodiment is characterized mainly by a portion which corresponds to the processes up to generating the first and second groups of vectors in the first embodiment. That is, in the second embodiment, as the attributes X and Y of the technical document, a problem term and a solution term included in the document are used, and as the score which is the vector component, an increase/decrease rate in number of technical documents in which a combination of the problem term and the solution term is the same is used. The processes for arranging the generated group of vectors, etc., are almost similar to those in the first embodiment. A detailed description is given of an operation procedure of the second embodiment below.

### 4-1. ACQUISITION OF GROUP OF TECHNICAL DOCUMENTS

Firstly, based on the acquisition condition of the group of documents to be analyzed, which is inputted from the input device 2, the data acquiring unit 110 acquires the group of technical documents to be analyzed (step S210). Types of acquired group of technical documents arbitrarily include a patent document, a technical paper, etc. However, it can be said that the patent document is particularly preferable because it is written in a format capable of extracting in a computer process the problem term and the solution term which are described next. The condition for acquiring the group of documents to be analyzed, may be designated by the IPC code, or documents which stay within a top predetermined number of a degree of similarity relative to a specific technical document may be acquired, for example.

### 4-2. SELECTION OF PROBLEM TERM AND SOLUTION TERM

Next, the data acquiring unit 110 extracts candidates for the “problem term” and the “solution term”, respectively, from each document of the acquired group of documents to be analyzed (step S211). When there are sections of “problem” and “solving means” in abstract or other parts of each document, for example, words in those parts are extracted. When a description of “A problem to be solved by the present invention is . . . ” or “To solve this problem, the present invention . . . ”, etc., is included in each document, for example, words are extracted from parts immediately after this description.

Next, the data acquiring unit 110 selects the “problem term” and the “solution term”, respectively, used for analysis, from the extracted candidates of “problem term” and “solution term” (step S212). For example, a method for selection may include that in which regarding each candidate of “problem term” and “solution term”, a top predetermined number (each 100 words, for example) of a document frequency (DF: the number of hit documents obtained when each index term is used to search in the group of documents to be analyzed) in the group of documents to be analyzed, but another method is possible.

### 4-3. CALCULATION OF FACTOR LOADING

Next, the data acquiring unit 110 uses the selected “problem term” to perform factor analysis so that a factor loading of each problem term is calculated (step S213). More specifically, the calculation is performed as follows:

Each document is expressed by i (i=1, 2, . . . , I), where I denotes the number of documents of the group of documents to be analyzed. Each problem term is expressed by g (g=1, 2, . . . , G), where G denotes the number of selected problem terms. A weighing amount z of each problem term g is calculated by each document i of I. As a result, the following data of I rows and G columns can be obtained. Herein, a matrix of I rows and G columns, where z denotes a matrix element, is Z.

TABLE 7

| | Index Term 1 | Index Term 2 | | Index Term G |
|---|---|---|---|---|
| Document 1 | z₁₁ | z₁₂ | . . . | z_{1G} |
| Document 2 | z₂₁ | z₂₂ | . . . | z_{2G} |
| Document 3 | z₃₁ | z₃₂ | . . . | z_{3G} |
| | . . . | . . . | . . . | . . . |
| Document I | z_{I1} | z_{I2} | . . . | z_{IG} |

Herein, the weighting amount is a numerical quantity applied in each document to each problem term from a predetermined viewpoint, and TFIDF, for example, is preferably used. The TFIDF is a value which relates to a certain index term and which is obtained by the product of an index term frequency (TF: the number of times of appearances of the problem term in a certain document) and an inverse of document frequency (DF: the number of documents in which the problem term appears out of a predetermined population of documents) or an inverse of a logarithm of the document frequency (IDF: inverse document frequency). A high TFIDF value is calculated for a problem term which is used many times in a document which is a subject to calculation of the document vector and which is not often used in a predetermined population of documents.

Next, a factor loading in factor analysis is calculated, where each document i is a subject, each problem term g is an observed variable, and each weighting amount z is an answer by the subject.

More specifically, H denotes the number of factors, h (h=1, 2, . . . , H) expresses each factor, and a_{gh} denotes a factor loading to each factor h of each problem term g. A symbol fᵢₕ denotes a factor score regarding each factor h of each document i. A factor loading matrix A in which factor loadings a_{gh} are matrix elements and a factor score matrix F in which factor scores fᵢₕ are matrix elements are set as follows:

TABLE 8

| | Factor 1 | Factor 2 | | Factor H |
|---|---|---|---|---|
| Index Term 1 | a₁₁ | a₁₂ | . . . | a_{1H} |
| Index Term 2 | a₂₁ | a₂₂ | . . . | a_{2H} |
| | . . . | . . . | . . . | . . . |
| Index Term G | a_{G1} | a_{G2} | . . . | a_{GH} |

TABLE 9

| | Factor 1 | Factor 2 | | Factor H |
|---|---|---|---|---|
| Document 1 | f₁₁ | f₁₂ | . . . | f_{1H} |
| Document 2 | f₂₁ | f₂₂ | . . . | f_{2H} |
| Document 3 | f₃₁ | f₃₂ | . . . | f_{3H} |
| | . . . | . . . | . . . | . . . |
| Document I | f_{I1} | f_{I2} | . . . | f_{IH} |

Next, when E denotes a residual matrix of I rows and G columns, the following equation is solved as described below to evaluate the factor loading matrix A:

Z=F×A^{t}+E, Equation

where Aₜ denotes a transposed matrix A.

With respect to the factor score fᵢₕ which is each element of a factor score matrix F and a residual e_{ig} which is each element of the residual matrix E, assuming conditions of (1) the factor score is normalized such that an average is 0 and a standard deviation is 1; (2) a correlation between each factor score is 0; (3) a correlation between each residual is 0; and (4) a correlation between each factor score and each residual is 0, the following equation is generally established:

R=AA^{t}+V, where R denotes a correlation matrix between observed variables, and V denotes a variance-covariance matrix of residuals.

Therefore, the factor loading is evaluated by the following equation:

AA^{t}=R−V.

Subsequently, R−V=R* is set. To calculate this R*, the correlation matrix R is calculated from the value of each element z_{ig} of the matrix Z, and in addition, a diagonal element of the correlation matrix is replaced by a commonality estimate to estimate an R* matrix (a commonality estimate method includes an SMC method, an RMAX method, etc., for example). Because of R*=AA^{t}, based on the R* matrix, the factor loading matrix A is calculated to evaluate the factor loading (a method of evaluating the factor loading includes a major factor method, a least squares method, a maximum likelihood method, etc., for example).

It is desired that to find a more meaningful factor, an operation of a factor rotation is performed. A method of rotating factor axes includes an orthogonal rotation such as a varimax, a quartimax, an equamax, a parsimax, an orthomax, an orthogonal procrustes, and an oblique rotation such as a promax, an oblimin, a Harris-Kaiser, an oblique procrustes.

The data acquiring unit 110 performs factor analysis also on the “solution term” to calculate a factor loading of each solution term (step S214). A calculating method of the factor loading includes the same methods as those described about the “problem term”.

### 4-4. SELECTION OF FACTOR

Next, the data acquiring unit 110 selects each predetermined number out of the factors (each of which is referred to as a “problem factor” and a “solution factor”), obtained as a result of the factor analysis of each of the problem term and the solution term (steps S215 and S216). For example, based on a unique value of each factor, factors of a top predetermined number of the unique values are selected. The number of selected factors is arbitrary. Herein, p of problem factors and q of solution factors are selected.

As compared to the first embodiment, in the second embodiment, the “problem factor” and the “solution factor” are selected as the two attributes X and Y, and top p of unique values of problem factors and a top q of unique values of solution factors are selected, respectively, as the range (range of value) of the attribute values.

### 4-5. DETERMINATION OF ATTRIBUTE FACTORS OF PROBLEM TERM AND SOLUTION TERM

Subsequently, the data acquiring unit 110 determines attribute factors of each problem term and each solution term, respectively (steps S217 and S218).

For example, when, out of the factor loading relative to each factor (which eliminates factors not selected in the above-described selection of factors) of a certain problem term (or a solution term) g, the factor loading a_{gh} relative to a certain factor h is the maximum, the attribute factor of the problem term (or the solution term) g is set to the factor h. In this case, the number of factors to which one problem term (or the solution term) can attribute is only one, but the number of problem terms (or the solution terms) which attribute to one factor is not limited to one.

It may be possible that when a lower limit value is provided to the factor loading, and the maximum value a_{gh} of the factor loading of a certain problem term (or a solution term) g is less than the lower limit value, the problem term (or the solution term) g does not attribute to any factor.

### 4-6. GENERATING MATRIX

Next, the score calculating unit 120 measures the number of technical documents by each combination of each problem term and each solution term determined by the attribute factor (step S220). For example, AND search in which a document including both of one problem term and one solution term determined by the attribute factor in the document or in an abstract thereof is searched is executed, and the number of hit documents is set to the number of the technical documents.

Subsequently, the score calculating unit 120 summarizes the number of documents by each combination of each problem factor and each solution factor (step S221). For example, with respect to all combinations of one of the problem terms which attribute to a certain problem factor and one of the solution terms which attribute to a certain solution factor, the number of the technical documents is summarized. For example, when it is assumed that there are three problem terms which attribute to a certain problem factor, i.e., Xg₁, Xg₂, and Xg₃, and there are two solution terms which attribute to a certain solution factor, i.e., Yg₁ and Yg₂, a total of the following numbers is the number of documents related to the combination of the problem factor and the solution factor, which are:

the number of the technical documents about (Xg₁, Yg₁);

the number of the technical documents about (Xg₁, Yg₂);

the number of the technical documents about (Xg₂, Yg₁);

the number of the technical documents about (Xg₂, Yg₂);

the number of the technical documents about (Xg₃, Yg₁); and

the number of the technical documents about (Xg₃, Yg₂).

A method of summarizing the number of documents by each combination of factors is not limited to that described above. For example, based on the factor score fᵢₕ related to each factor h of each document i calculated by the above-described factor analysis, a combination of factors to which each document attributes is determined, and based thereon, the number of documents may be summarized.

When numbers of documents related to a combination of each problem factor and each solution factor are each calculated, there are p×q of combinations of p of problem factors and q of solution factors. As a result, a document-number matrix of p rows and q columns is obtained.

This document-number matrix indicates how many technical documents exist regarding each combination of problem factors and solution factors. This matrix is helpful in grasping what problem and solving means attract attention in a certain technical field, finding out a plurality of problems (uses) which can be solved by the technology by focusing on a specific solution factor (a certain row in the matrix), and finding out a plurality of solving means for the problem by focusing on a specific problem factor (a certain column in the matrix).

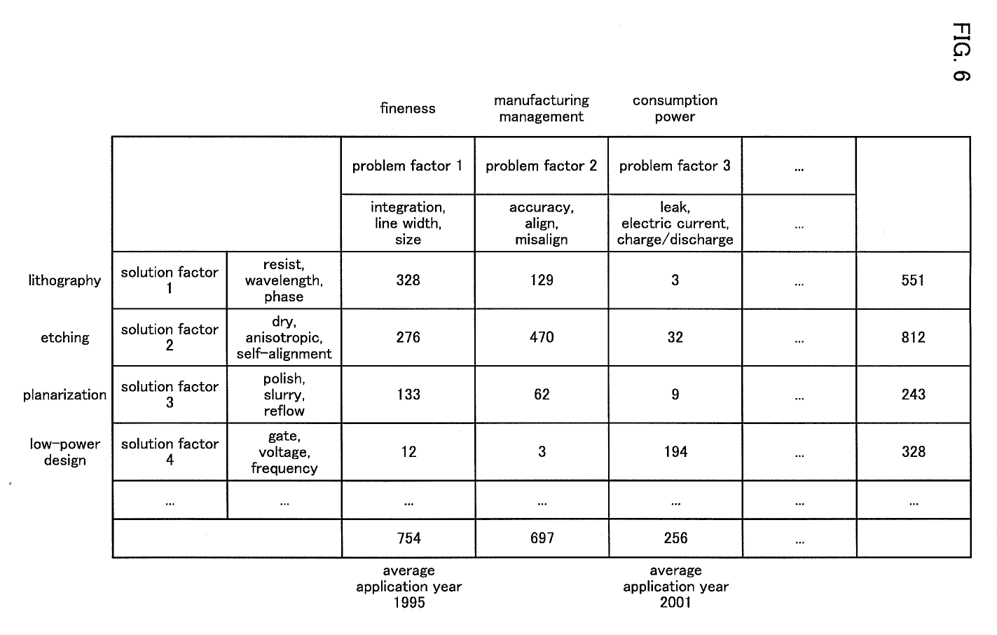

FIG. 6 shows one example of a document-number matrix generated in a second embodiment. This document-number matrix is obtained by extracting patent documents which stay within a top predetermined number of a degree of similarity relative to a certain patent document i which relates to a “semiconductor device and a manufacturing method therefore” and performing the factor analysis on each of the problem term and the solution term according to the above-described method. A marginal note of this matrix mentions meanings of factors interpreted by an analyzer based on a group of problem terms and a group of solution terms included in each problem factor and each solution factor.

Firstly, the matrix is observed vertically. When the number of patent documents on a vertical axis is summarized, main problems of the group of documents to be analyzed become apparent. In this example, the number of a problem factor 1 and that of a problem factor 2 are large. Therefore, in a group of similar documents of the patent document i which relates to the “semiconductor device and the manufacturing method thereof”, it can be said that the main problems are “fineness” and “manufacturing management”. Further, when an average application year by each column is calculated, it is understood that in a problem factor 3, the number is small but relatively new patent documents are concentrated. That is, it is understood that the main problems move from the “fineness” and the “manufacturing management” to “consumption power”. The reason for that is probably because a current trend is gradually moved from a mounting-type use of a personal computer, etc., to a battery-driven use of a mobile terminal, etc.

Next, the matrix is observed horizontally. With respect to a problem factor 1, there are a large number of patent documents of solution factors 1 and 2. That is, it is understood that with respect to the finesses, lithography and etching are main solving means. Further, relative to a problem factor 2, the solution factor 2 also has a large number of patent documents. That is, the etching can be effective solving means in the manufacturing management as well. It becomes possible to perform various analysis by observing an applicant configuration of each solution factor in the problem factor 1, or observing a transition by each year while focusing on a certain box, and so on, for example.

As described above, when one of the attributes is the problem factor and the other one is the solution factor, if the problem factor represents inconvenience which can occur in any use and the solution factor represents a technology capable of solving the inconvenience, it is possible to analogize the use from the problem factor and the technology from the solution factor.

Further, when each solution factor for a certain problem is summarized by each company, it becomes possible to analyze a technology strategy of each company for the same problem.

When each element (the number of documents) of the document-number matrix of p rows and q columns is the score σₖⱼ, the first and second groups of vectors are generated similarly to the first embodiment, and the vectors are arranged based on the association between each vector, it may be adapted to analyze a state of concentration or dispersion of the problem factors and the solution factors. Furthermore, in the second embodiment, the group of vectors is generated as follows:

### 4-7. GENERATING INCREASE/DECREASE RATE MATRIX

The score calculating unit 120 classifies each element of the document-number matrix of p rows and q columns into each predetermined period (step S222). In the case of the patent document, for example, a classification by each application year or by each plurality of years may be considered. Preferably, the predetermined period is used as a boundary before and after which the classification is made into two periods.

Subsequently, with respect to each element of the document-number matrix of p rows and q columns, the score calculating unit 120 calculates an increase/decrease rate of the number of technical documents based on the classification by each above-described predetermined period. When the classification by each predetermined period is that into the two periods, one increase/decrease rate is calculated by each element of the document-number matrix of p rows and q columns, and thus, one increase/decrease rate matrix of p rows and q columns is generated. When the classification by each predetermined period is that into T periods (T≧3), the increase/decrease rate matrix of p rows and q columns may be generated by each adjacent period to generate (T−1) of matrixes, or to generate one matrix of an average increase/decrease rate.

By means of the increase/decrease rate matrix thus generated, it becomes possible to perceive a change in trend of the problem or the solving means. For example, it becomes possible to find out a change in use of the technology by focusing on a specific solution factor (one certain row in the matrix), or to find out a change in solving means for the problem by focusing on a specific problem factor (one certain column in the matrix).

### 4-8. GENERATION OF VECTOR, ETC

The subsequent processes are similar to those in the first embodiment. By the first and second group-of-vectors generating units 130 and 140, the first and second groups of vectors are generated in which each element (increase/decrease rate) of this increase/decrease rate matrix of p rows and q columns is the score σₖⱼ (steps S230 and S240).

By the first and second vector association calculating units 150 and 160, the association between each vector is calculated (steps S250 and S260), and by the first and second vector arranging units 170 and 180, the arrangement of each vector is performed (steps S271 to S278 and S281 to S288).

With respect to the first and second groups of vectors, in the second embodiment, a q-dimensional vector related to p of problem factors is referred to as a “problem-factor number-of-publications increase/decrease rate vector”, and a p-dimensional vector related to q of solution factors is referred to as a “solution-factor number-of-publications increase/decrease rate vector”. In the second embodiment, the first and second clusters are referred to as a “problem factor cluster” and a “solution factor cluster”, respectively.

When the vector arrangement is performed in the increase/decrease rate matrix, it becomes possible to analyze a state of concentration or dispersion regarding a trend of the problem factor and the solution factor.

When each element of the matrix is set to the increase/decrease rate of the number of documents, etc., it becomes possible to grasp in detail a temporal transition of the problem factor (use) and the solution factor (technology). In particular, it becomes possible to visualize so that a problem factor (use) and a solution factor (technology) which increase or decrease significantly in the matrix can be quickly grasped. Further, there may be cases where an element of which the number tends to increase can be discovered.

When a specific solution factor (technology) tends to increase with respect to a certain problem factor (use), it can be perceived that the mainstream technology of the use is changing. Likewise, it also is possible to comprehend a sign which indicates that a use of a certain technology is about to change. This means the transfer possibility of a fundamental technology to a new need, and this may lead the way toward a foundation for forming a technical development strategy based on the seeds.

### 5. ANOTHER EMBODIMENT

The present invention is not limited to the above-described embodiments, and can be modified in various ways within a scope of the gist of the present invention.

For example, in the first embodiment, the description is given of the case where in the attribute arranged on each axis of the matrix, one is the person attribute and the other is the technical field attribute, and as an example of the person attribute, the applicant is used. However, this is only illustrative. For the person attribute, another person information such as an inventor, may be used. In this case also, an operation effect similar to that in the first embodiment can be obtained.

In the second embodiment, the description is given of the case where the number of documents is utilized for the score which forms each element of the matrix and the case where the increase/decrease rate of the number of documents, etc., is used. However, the embodiment is not limited thereto. An arbitrary score corresponding to the data of the technical document may be used for the score which forms each element of the matrix.

Only one matrix may be generated to one group of technical documents to be analyzed. A plurality of sheets of matrixes may be generated by classifying each element of a certain matrix into each predetermined period, for example, to divide the matrix by each predetermined period.

When a plurality of sheets of matrixes are generated by dividing the matrix by each predetermined period and so on, if the patent documents in the matrix element are followed by each application year, it becomes possible to generally grasp a trend (a technology trend for a certain use, for example) of the group of documents to be analyzed. When one of the attributes is the problem factor and the other is the solution factor, for example, several uses, the technology for the uses, and main problems are arranged in order, and it is thus possible to exhaustively grasp what solving means served as a mainstream and when the solving means served as a mainstream.

In the increase/decrease rate association matrix generating process (see FIGS. 5A and 5B) described in the second embodiment, after the process at the step S221, the matrix is classified by each predetermined period (S222), the increase/decrease rate of the number of publications is calculated by each combination of each problem factor and each solution factor in the predetermined periods (S223), and thereafter, the processes at S230 to S227 (or S240 to 287) are performed. However, the order is not particularly limited thereto. For example, the processes at the S222 and S223 may be performed after the process at the S277 (or the process at the S287) instead of after the S221.

In this way, when the association matrix in the problem factor and the solution factor which configure the axes of the matrix is generated, similar problem factors and similar solution factors are contacted next to each other, respectively. Therefore, problem solving means in a predetermined technical field to be analyzed is consolidated, and thus, it becomes possible to classify into several uses, the technology for the uses, and the main problems.

Further, the increase/decrease rate is calculated by each element of the association matrix. As a result, it is possible to grasp the problem with which this field is directly faced and which increasingly attracts attention, and the technology being intensively worked on as means for solving the problem.

1-11. (canceled)

12. A technical document attribute association analysis supporting apparatus, comprising:
data acquiring means for acquiring data of a group of technical documents including a plurality of technical documents each of which has at least a first attribute X and a second attribute Y;
score calculating means for calculating scores corresponding to data of the technical documents having each combination (Xⱼ, Yₖ) of a value Xⱼ (j=1, 2, . . . , p) of the first attribute X and a value Yₖ (k=1, 2, . . . , q) of the second attribute Y, for each combination (Xⱼ, Yₖ), using the acquired data of the group of technical documents; and
means for generating a matrix where the scores each of which is calculated for each combination (Xⱼ, Yₖ) are arranged in a matrix manner in which the value Xⱼ (j=1, 2, . . . , p) of the first attribute X is placed on a horizontal axis and the value Yₖ (k=1, 2, . . . , q) of the second attribute Y is placed on a vertical axis;
wherein the apparatus further comprises:
first arranging means for calculating mutual associations of first vectors having values as their components obtained from scores belonging to each column of the generated matrix and arranging the first vectors of high association closer to each other than the first vector of low association so as to re-arrange the columns of the matrix; and/or
second arranging means for calculating mutual associations of second vectors having values as their components obtained from scores belonging to each row of the generated matrix and arranging the second vectors of high association closer to each other than the second vector of low association so as to re-arrange the rows of the matrix;
wherein the first arranging means re-arranges the columns of the matrix by executing:
a process of generating a first cluster to select two vectors having the highest mutual association out of the first vectors and to bring the two vectors next to each other; and
a process of enlarging the first cluster to repeat, until a predetermined condition is satisfied, taking end vectors positioned at both ends out of the first vectors configuring the generated first cluster as targets of comparing associations with the first vectors other than the first cluster, selecting a vector having the highest association with either one of the end vectors from the first vectors other than the first cluster out of the first vectors, and bringing and adding the selected first vector next to an end vector which is determined to have the highest association with the selected vector; and
wherein the second arranging means re-arranges the rows of the matrix by executing:
a process of generating a second cluster to select two vectors having the highest mutual association out of the second vectors and to bring the two vectors next to each other; and
a process of enlarging the second cluster to repeat, until a predetermined condition is satisfied, taking end vectors positioned at both ends out of the second vectors configuring the generated second cluster as targets of comparing associations with the second vectors other than the second cluster, selecting a vector having the highest association with either one of the end vectors from the second vectors other than the second cluster out of the second vectors, and bringing and adding the selected second vector next to an end vector which is determined to have the highest association with the selected vector.

13. The technical document attribute association analysis supporting apparatus according to claim 12,
wherein the first arranging means stops the process of enlarging the first cluster and proceeds to a process of generating a new first cluster when any association between the end vectors positioned at both ends, out of the group of vectors configuring the first cluster, and the first vectors other than the first cluster is equal to or less than a predetermined threshold value;
wherein the process of generating a new first cluster includes:
a process to select two vectors having the highest mutual association out of the first vectors other than the first cluster and to bring the two vectors next to each other to generate a new first cluster; and
a process of enlarging the new first cluster to repeat, until any associations of the first vectors not belonging to any cluster and the end vectors become equal to or less than a predetermined threshold or until all of the first vectors are added to the first cluster or the new first cluster, selecting a vector having the highest association with either one of the end vectors positioned at both ends, out of the group of vectors configuring the new first cluster, from the first vectors other than the first cluster and other than the new first cluster, and bringing and adding the selected first vector next to an end vector which is determined to have the highest association with the selected vector;
wherein the process of generating a new first cluster is repeated when any associations of the first vectors not belonging to any cluster and the end vectors become equal to or less than the predetermined threshold;
wherein the first cluster and the new first cluster are brought adjacent to each other when all of the first vectors are added to the first cluster or the new first cluster, thereby re-arrange the columns of the matrix;
wherein the second arranging means stops the process of enlarging the second cluster and proceeds to a process of generating a new second cluster when any association between the end vectors positioned at both ends, out of the group of vectors configuring the second cluster, and the second vectors other than the second cluster is equal to or less than a predetermined threshold value;
wherein the process of generating a new second cluster includes:
a process to select two vectors having the highest mutual association out of the second vectors other than the second cluster and to bring the two vectors next to each other to generate a new second cluster; and
a process of enlarging the new second cluster to repeat, until any associations of the second vectors not belonging to any cluster and the end vectors become equal to or less than a predetermined threshold or until all of the second vectors are added to the second cluster or the new second cluster, selecting a vector having the highest association with either one of the end vectors positioned at both ends, out of the group of vectors configuring the new second cluster, from the second vectors other than the second cluster and other than the new second cluster, and bringing and adding the selected second vector next to an end vector which is determined to have the highest association with the selected vector;
wherein the process of generating a new second cluster is repeated when any associations of the second vectors not belonging to any cluster and the end vectors become equal to or less than the predetermined threshold; and
wherein the second cluster and the new second cluster are brought adjacent to each other when all of the second vectors are added to the second cluster or the new second cluster, thereby re-arrange the rows of the matrix.

14. A technical document attribute association analysis supporting apparatus, comprising:
data acquiring means for acquiring data of a group of technical documents including a plurality of technical documents each of which has at least a first attribute X and a second attribute Y;
score calculating means for calculating scores corresponding to data of the technical documents having each combination (Xⱼ, Yₖ) of a value Xⱼ (j=1, 2, . . . , p) of the first attribute X and a value Yₖ (k=1, 2, . . . , q) of the second attribute Y, for each combination (Xⱼ, Yₖ), using the acquired data of the group of technical documents; and
means for generating a matrix where the scores each of which is calculated for each combination (Xⱼ, Yₖ) are arranged in a matrix manner in which the value Xⱼ (j=1, 2, . . . , p) of the first attribute X is placed on a horizontal axis and the value Yₖ (k=1, 2, . . . , q) of the second attribute Y is placed on a vertical axis;
wherein the apparatus further comprises:
first arranging means for calculating mutual associations of first vectors having values as their components obtained from scores belonging to each column of the generated matrix and arranging the first vectors of high association closer to each other than the first vector of low association so as to re-arrange the columns of the matrix; and/or
second arranging means for calculating mutual associations of second vectors having values as their components obtained from scores belonging to each row of the generated matrix and arranging the second vectors of high association closer to each other than the second vector of low association so as to re-arrange the rows of the matrix; and
wherein the score calculating means calculates the scores by applying weightings defined by the value of the attribute of the technical documents having the same combination (Xⱼ, Yₖ) of values Xⱼ (j=1, 2, . . . , p) of the first attribute X and values Yₖ (k=1, 2, . . . , q) of the second attribute Y to the number of technical document and totaling them.

15. A technical document attribute association analysis supporting apparatus, comprising:
data acquiring means for acquiring data of a group of technical documents including a plurality of technical documents each of which has at least a first attribute X and a second attribute Y;
score calculating means for calculating scores corresponding to data of the technical documents having each combination (Xⱼ, Yₖ) of a value Xⱼ (j=1, 2, . . . , p) of the first attribute X and a value Yₖ (k=1, 2, . . . , q) of the second attribute Y, for each combination (Xⱼ, Yₖ), using the acquired data of the group of technical documents; and
means for generating a matrix where the scores each of which is calculated for each combination (Xⱼ, Yₖ) are arranged in a matrix manner in which the value Xⱼ (j=1, 2, . . . , p) of the first attribute X is placed on a horizontal axis and the value Yₖ (k=1, 2, . . . , q) of the second attribute Y is placed on a vertical axis;
wherein the apparatus further comprises:
first arranging means for calculating mutual associations of first vectors which include, as a component, a logarithm of each of the scores belonging to each column of the generated matrix and arranging the first vectors of high association closer to each other than the first vector of low association so as to re-arrange the columns of the matrix; and/or
second arranging means for calculating mutual associations of second vectors which include, as a component, a logarithm of each of the scores belonging to each row of the generated matrix and arranging the second vectors of high association closer to each other than the second vector of low association so as to re-arrange the rows of the matrix.

16. The technical document attribute association analysis supporting apparatus according to claim 12,
wherein one of the first attribute X and the second attribute Y is a person attribute of each technical document and the other is a technical field attribute of each technical document.

17. The technical document attribute association analysis supporting apparatus according to claim 12, further comprising:
display means for displaying a distribution state of scores re-arranged by the first arranging means and the second arranging means by adding a pattern or a color corresponding to the scores.

18. A technical document attribute association analysis method executed by an information processing device, comprising:
a data acquiring step for acquiring data of a group of technical documents including a plurality of technical documents each of which has at least a first attribute X and a second attribute Y;
a score calculating step for calculating scores corresponding to data of the technical documents having each combination (Xⱼ, Yₖ) of a value Xⱼ (j=1, 2, . . . , p) of the first attribute X and a value Yₖ (k=1, 2, . . . , q) of the second attribute Y, for each combination (Xⱼ, Yₖ), using the acquired data of the group of technical documents;
a step for generating a matrix where the scores each of which is calculated for each combination (Xⱼ, Yₖ) are arranged in a matrix manner in which the value Xⱼ (j=1, 2, . . . , p) of the first attribute X is placed on a horizontal axis and the value Yₖ (k=1, 2, . . . , q) of the second attribute Y is placed on a vertical axis;
a first arranging step for calculating mutual associations of first vectors having values as their components obtained from scores belonging to each column of the generated matrix and arranging the first vectors of high association closer to each other than the first vector of low association so as to re-arrange the columns of the matrix; and
a second arranging step for calculating mutual associations of second vectors having values as their components obtained from scores belonging to each row of the generated matrix and arranging the second vectors of high association closer to each other than the second vector of low association so as to re-arrange the rows of the matrix;
wherein the first arranging step re-arranges the columns of the matrix by executing:
a process of generating a first cluster to select two vectors having the highest mutual association out of the first vectors and to bring the two vectors next to each other; and
a process of enlarging the first cluster to repeat, until a predetermined condition is satisfied, taking end vectors positioned at both ends out of the first vectors configuring the generated first cluster as targets of comparing associations with the first vectors other than the first cluster, selecting a vector having the highest association with either one of the end vectors from the first vectors other than the first cluster out of the first vectors, and bringing and adding the selected first vector next to an end vector which is determined to have the highest association with the selected vector; and
wherein the second arranging step re-arranges the rows of the matrix by executing:
a process of generating a second cluster to select two vectors having the highest mutual association out of the second vectors and to bring the two vectors next to each other; and
a process of enlarging the second cluster to repeat, until a predetermined condition is satisfied, taking end vectors positioned at both ends out of the second vectors configuring the generated second cluster as targets of comparing associations with the second vectors other than the second cluster, selecting a vector having the highest association with either one of the end vectors from the second vectors other than the second cluster out of the second vectors, and bringing and adding the selected second vector next to an end vector which is determined to have the highest association with the selected vector.

19. A program for technical document attribute association analysis for causing an information processing device to execute:
a data acquiring step for acquiring data of a group of technical documents including a plurality of technical documents each of which has at least a first attribute X and a second attribute Y;
a score calculating step for calculating scores corresponding to data of the technical documents having each combination (Xⱼ, Yₖ) of a value Xⱼ (j=1, 2, . . . , p) of the first attribute X and a value Yₖ (k=1, 2, . . . , q) of the second attribute Y, for each combination (Xⱼ, Yₖ), using the acquired data of the group of technical documents;
a step for generating a matrix where the scores each of which is calculated for each combination (Xⱼ, Yₖ) are arranged in a matrix manner in which the value Xⱼ (j=1, 2, . . . , p) of the first attribute X is placed on a horizontal axis and the value Yₖ (k=1, 2, . . . , q) of the second attribute Y is placed on a vertical axis;
a first arranging step for calculating mutual associations of first vectors having values as their components obtained from scores belonging to each column of the generated matrix and arranging the first vectors of high association closer to each other than the first vector of low association so as to re-arrange the columns of the matrix; and
a second arranging step for calculating mutual associations of second vectors having values as their components obtained from scores belonging to each row of the generated matrix and arranging the second vectors of high association closer to each other than the second vector of low association so as to re-arrange the rows of the matrix;
wherein the first arranging step re-arranges the columns of the matrix by executing:
a process of generating a first cluster to select two vectors having the highest mutual association out of the first vectors and to bring the two vectors next to each other; and
a process of enlarging the first cluster to repeat, until a predetermined condition is satisfied, taking end vectors positioned at both ends out of the first vectors configuring the generated first cluster as targets of comparing associations with the first vectors other than the first cluster, selecting a vector having the highest association with either one of the end vectors from the first vectors other than the first cluster out of the first vectors, and bringing and adding the selected first vector next to an end vector which is determined to have the highest association with the selected vector; and
wherein the second arranging step re-arranges the rows of the matrix by executing:
a process of generating a second cluster to select two vectors having the highest mutual association out of the second vectors and to bring the two vectors next to each other; and
a process of enlarging the second cluster to repeat, until a predetermined condition is satisfied, taking end vectors positioned at both ends out of the second vectors configuring the generated second cluster as targets of comparing associations with the second vectors other than the second cluster, selecting a vector having the highest association with either one of the end vectors from the second vectors other than the second cluster out of the second vectors, and bringing and adding the selected second vector next to an end vector which is determined to have the highest association with the selected vector.

20. An association analysis supporting apparatus for acquiring a plurality of digitized technical documents and analyzing technical trends using the technical documents,
wherein each technical document includes problem information showing technical problems and solution information showing solving means for the problem, and
wherein the apparatus comprises:
means for extracting words which satisfy a predetermined criterion from the problem information as problem terms and extracting words which satisfy another predetermined criterion from the solution information as solution terms for each acquired technical document;
means for classifying the problem terms to a predetermined number of problem groups and classifying the solution terms to a predetermined number of solution groups by using the technical documents;
means for calculating a score, for each combination of the problem group and the solution group, by counting the number of technical documents including each set of the problem terms classified to the problem group and the solution terms classified to the solution group out of the acquired technical documents; and
means for generating a matrix where the score of each combination is arranged in a matrix manner in which the problem group is placed on one axis and the solution group is placed on another axis.

21. An association analysis supporting apparatus for acquiring a plurality of digitized technical documents and analyzing technical trends using the technical documents,
wherein each technical document includes problem information showing technical problems and solution information showing solving means for the problem, and
wherein the apparatus comprises:
means for extracting words which satisfy a predetermined criterion from the problem information as problem terms and extracting words which satisfy another predetermined criterion from the solution information as solution terms;
means for calculating a weighting for each problem term and calculating a weighting for each solution term by using the acquired technical documents;
means for performing a factor analysis using each technical document as a subject, using each problem term as an observed variable and using the weighting of each problem term as an observed data, calculating factor loading for each problem term to extract a plurality of problem factors, selecting a problem factor in which a factor loading is maximum for each problem term and associating the problem term with the selected problem factor;
means for performing a factor analysis using each technical document as a subject, using each solution term as an observed variable and using the weighting of each solution term as an observed data, calculating factor loading for each solution term to extract a plurality of solution factors, selecting a solution factor in which a factor loading is maximum for each solution term and associating the solution term with the selected solution factor;
means for calculating a score, for each combination of the problem factor and the solution factor, by using the acquired technical documents and the set of the problem terms associated with the problem factor and the solution terms associated with the solution factor; and
means for generating a matrix where the score of each combination is arranged in a matrix manner in which the problem factor is placed on one axis and the solution factor is placed on another axis.

22. The association analysis supporting apparatus according to claim 21,
wherein the means for calculating a score calculates the score, for each combination of the problem factor and the solution factor, by counting the number of technical documents including each set of the problem terms associated with the problem factor and the solution terms associated with the solution factor out of the acquired technical documents.

23. The association analysis supporting apparatus according to claim 21,
wherein the technical documents are patent documents or technical papers each of which includes at least time information showing an application year or a publication year; and
wherein the means for calculating a score counts, by using the time information, the number of technical documents including each set of the problem terms associated with the problem factor and the solution terms associated with the solution factor for each predetermined period and calculates, by using the number of technical documents for each predetermined period, an increase/decrease rate for each combination of the problem factor and the solution factor as the score.

24. The association analysis supporting apparatus according to claim 20, further comprising:
first arranging means for calculating mutual associations of first vectors having values as their components obtained from scores belonging to each column of the generated matrix and arranging the first vectors of high association closer to each other than the first vector of low association so as to re-arrange the columns of the matrix; and/or
second arranging means for calculating mutual associations of second vectors having values as their components obtained from scores belonging to each row of the generated matrix and arranging the second vectors of high association closer to each other than the second vector of low association so as to re-arrange the rows of the matrix;
wherein the first arranging means re-arranges the columns of the matrix by executing:
a process of generating a first cluster to select two vectors having the highest mutual association out of the first vectors and to bring the two vectors next to each other; and
a process of enlarging the first cluster to repeat, until a predetermined condition is satisfied, taking end vectors positioned at both ends out of the first vectors configuring the generated first cluster as targets of comparing associations with the first vectors other than the first cluster, selecting a vector having the highest association with either one of the end vectors from the first vectors other than the first cluster out of the first vectors, and bringing and adding the selected first vector next to an end vector which is determined to have the highest association with the selected vector; and
wherein the second arranging means re-arranges the rows of the matrix by executing:
a process of generating a second cluster to select two vectors having the highest mutual association out of the second vectors and to bring the two vectors next to each other; and
a process of enlarging the second cluster to repeat, until a predetermined condition is satisfied, taking end vectors positioned at both ends out of the second vectors configuring the generated second cluster as targets of comparing associations with the second vectors other than the second cluster, selecting a vector having the highest association with either one of the end vectors from the second vectors other than the second cluster out of the second vectors, and bringing and adding the selected second vector next to an end vector which is determined to have the highest association with the selected vector.

25. The association analysis supporting apparatus according to claim 21,
wherein the technical documents are patent documents or technical papers each of which includes at least time information showing an application year or a publication year;
wherein the apparatus further comprises:
first arranging means for calculating mutual associations of first vectors having values as their components obtained from scores belonging to each column of the generated matrix and arranging the first vectors of high association closer to each other than the first vector of low association so as to re-arrange the columns of the matrix; and/or
second arranging means for calculating mutual associations of second vectors having values as their components obtained from scores belonging to each row of the generated matrix and arranging the second vectors of high association closer to each other than the second vector of low association so as to re-arrange the rows of the matrix; and
increase/decrease rate matrix generating means;
wherein the first arranging means re-arranges the columns of the matrix by executing:
a process of generating a first cluster to select two vectors having the highest mutual association out of the first vectors and to bring the two vectors next to each other; and
a process of enlarging the first cluster to repeat, until a predetermined condition is satisfied, taking end vectors positioned at both ends out of the first vectors configuring the generated first cluster as targets of comparing associations with the first vectors other than the first cluster, selecting a vector having the highest association with either one of the end vectors from the first vectors other than the first cluster out of the first vectors, and bringing and adding the selected first vector next to an end vector which is determined to have the highest association with the selected vector; and
wherein the second arranging means re-arranges the rows of the matrix by executing:
a process of generating a second cluster to select two vectors having the highest mutual association out of the second vectors and to bring the two vectors next to each other; and
a process of enlarging the second cluster to repeat, until a predetermined condition is satisfied, taking end vectors positioned at both ends out of the second vectors configuring the generated second cluster as targets of comparing associations with the second vectors other than the second cluster, selecting a vector having the highest association with either one of the end vectors from the second vectors other than the second cluster out of the second vectors, and bringing and adding the selected second vector next to an end vector which is determined to have the highest association with the selected vector; and
wherein the increase/decrease rate matrix generating means classifies, by using the matrix re-arranged by the first arranging means and the second arranging means and the time information, the number of technical documents which is a component of the matrix and is associated with each combination of the problem factor and the solution factor for each predetermined period and calculates, by using the classified number, an increase/decrease rate for each combination of the problem factor and the solution factor to generate a matrix having the calculated increase/decrease rate as the components thereof.

26. The technical document attribute association analysis supporting apparatus according to claim 14,
wherein one of the first attribute X and the second attribute Y is a person attribute of each technical document and the other is a technical field attribute of each technical document.

27. The technical document attribute association analysis supporting apparatus according to claim 15,
wherein one of the first attribute X and the second attribute Y is a person attribute of each technical document and the other is a technical field attribute of each technical document.

28. The technical document attribute association analysis supporting apparatus according to claim 14, further comprising:
display means for displaying a distribution state of scores re-arranged by the first arranging means and the second arranging means by adding a pattern or a color corresponding to the scores.

29. The technical document attribute association analysis supporting apparatus according to claim 15, further comprising:
display means for displaying a distribution state of scores re-arranged by the first arranging means and the second arranging means by adding a pattern or a color corresponding to the scores.

30. The association analysis supporting apparatus according to claim 21, further comprising:
first arranging means for calculating mutual associations of first vectors having values as their components obtained from scores belonging to each column of the generated matrix and arranging the first vectors of high association closer to each other than the first vector of low association so as to re-arrange the columns of the matrix; and/or
second arranging means for calculating mutual associations of second vectors having values as their components obtained from scores belonging to each row of the generated matrix and arranging the second vectors of high association closer to each other than the second vector of low association so as to re-arrange the rows of the matrix;
wherein the first arranging means re-arranges the columns of the matrix by executing:
a process of generating a first cluster to select two vectors having the highest mutual association out of the first vectors and to bring the two vectors next to each other; and
a process of enlarging the first cluster to repeat, until a predetermined condition is satisfied, taking end vectors positioned at both ends out of the first vectors configuring the generated first cluster as targets of comparing associations with the first vectors other than the first cluster, selecting a vector having the highest association with either one of the end vectors from the first vectors other than the first cluster out of the first vectors, and bringing and adding the selected first vector next to an end vector which is determined to have the highest association with the selected vector; and
wherein the second arranging means re-arranges the rows of the matrix by executing:
a process of generating a second cluster to select two vectors having the highest mutual association out of the second vectors and to bring the two vectors next to each other; and
a process of enlarging the second cluster to repeat, until a predetermined condition is satisfied, taking end vectors positioned at both ends out of the second vectors configuring the generated second cluster as targets of comparing associations with the second vectors other than the second cluster, selecting a vector having the highest association with either one of the end vectors from the second vectors other than the second cluster out of the second vectors, and bringing and adding the selected second vector next to an end vector which is determined to have the highest association with the selected vector.
